(19) United States
(12) Patent Application Publication
(10) Pub. No.: US 2026/0088933 A1
(43) Pub. Date: Mar. 26, 2026

(54) WIRELESS COMMUNICATION METHOD AND RELATED PRODUCTS

(71) Applicant: Huawei Technologies Co., Ltd., Shenzhen (CN)

(72) Inventors: Hao Tang, Ottawa (CA); Jianglei Ma, Ottawa (CA); Huazi Zhang, Hangzhou (CN)

(21) Appl. No.: 19/402,766

(22) Filed: Nov. 26, 2025

Related U.S. Application Data
(63) Continuation of application No. PCT/CN2023/115075, filed on Aug. 25, 2023.
(60) Provisional application No. 63/505,551, filed on Jun. 1, 2023.

(51) Int. Cl. H04L 1/00; H04L 5/00; H04W 72/232

(52) U.S. Cl. CPC H04L 1/0061; H04L 5/0005; H04W 72/232

(57) ABSTRACT

Provided are a wireless communication method and related products. The method includes: receiving, by a first terminal device, a first indication from a network device, where the first indication is indicative of joint coding on a first resource. Another method includes sending a first indication to a first terminal device, where the first indication is indicative of joint coding on a first resource.

### CROSS-REFERENCE TO RELATED APPLICATIONS

This application is a continuation of International Application No. PCT/CN2023/115075, filed on Aug. 25, 2023, which claims priority to U.S. provisional patent application No. 63/505,551 entitled “INTER-UE MIXED TRAFFIC COOPERATION” and filed on Jun. 1, 2023, each of which are hereby incorporated by reference in their entirety.

### TECHNICAL FIELD

The present disclosure relates generally to the field of communication technologies and, in particular, to wireless communication methods and related products.

### BACKGROUND

Resilience is a fundamental feature that needs to be addressed in a sixth generation (6G) mobile communications technology. Two trends are observed toward 6G. From the technological perspective, mmWave and massive multiple-input multiple-output (MIMO) will be more prevalent because they can significantly expand the current bandwidth resource. From the service perspective, a single device will need to support multiple services with different latency and reliability requirements.

A potential scenario emerges as multiple services converges into one physical wireless link. The purpose is to deliver multiple quality of service (QoS) to multiple services within one wireless link. Given the high carrier frequency and massive antennas, beamforming can be done more aggressively, enabling the convergence of multiple services in one wireless link. Meanwhile, these services may have very diverse key performance indicators (KPIs). This is challenging because different KPIs must be supported under the same wireless channel.

This background information is provided to reveal information believed by the applicant to be of possible relevance to the present disclosure. No admission is necessarily intended, nor should be construed, that any of the preceding information constitutes prior art against the present disclosure.

### SUMMARY

In a first aspect, an embodiment of the present disclosure provides a wireless communication method, where the method includes:
receiving, by a first terminal device, a first indication from a network device, where the first indication is indicative of joint coding on a first resource.

Since the joint coding is enabled on the first resource, reliability of data transmitted on the first resource can be improved.

In a possible implementation of the first aspect, the joint coding on the first resource is joint coding for first data for the first terminal device and second data for a second terminal device.

By enabling the joint coding between different terminal devices, not only can the latency and reliability requirements of the second data for the second terminal device be improved, but also the performance of the first terminal device can be ensured.

In a possible implementation of the first aspect, the first data of the first terminal device and the second data of the second terminal device are jointly coded into a first codeword; where the first codeword includes a plurality of encoded blocks generated by encoding the first data and the second data with an error correction code, and the plurality of encoded blocks include a self-decodable encoded block corresponding to the second data, where the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

Multiple decoding attempts are allowed, and thus a success rate of decoding of the first data and the second data and reliability thereof can be improved and a code rate can be reduced, resulting in an improved performance.

In a possible implementation of the first aspect, the first indication is carried in first downlink control information (DCI); where the first DCI is indicative of at least one of: a coding rate of the first data, a coding rate of the second data, resource information of the second data, a code block index of the first data.

In a possible implementation of the first aspect, the first DCI is indicative of the first resource in a reference resource region by at least one of: an M-by-N time-frequency bitmap corresponding to the reference resource region, where M and N are integers greater than 0; an index in a resource allocation table corresponding to the reference resource region; a resource location of the first resource in the reference resource region; where the reference resource region is configured through a radio resource control (RRC) signaling or predefined.

Indication of the first resource used for the joint coding can be flexible.

In a possible implementation of the first aspect, a first radio network temporary identifier (RNTI) is used for scrambling a physical downlink shared channel (PDSCH) for the first data and the second data.

In a possible implementation of the first aspect, the first RNTI is different from a cell-radio network temporary identifier (C-RNTI) of the first terminal device, and the first RNTI is different from a C-RNTI of the second terminal device.

The first RNTI (i.e., mixed RNTI) is proposed to support the joint coding between different terminal devices, so as to be distinguish from, and be better compatible with, other types of joint coding.

In a possible implementation of the first aspect, the method further includes: receiving, by the first terminal device, second DCI from the network device, where the second DCI is used for scheduling third data, and the third data includes the first data.

In a possible implementation of the first aspect, after receiving, by the first terminal device, the first indication from the network device, the method further includes: determining, by the first terminal device, that a second resource scheduled by the second DCI for the third data overlaps with at least part of the first resource; determining, by the first terminal device, that data scheduled by the second DCI on the second resource is not transmitted by the network device.

By enabling joint coding between different terminal devices and providing special DCI (i.e., the first DCI carrying the first indication) in a pre-emption solution, not only can the latency and reliability requirements of the second data for the second terminal device be improved, but also the performance of the first terminal device can be ensured.

In a possible implementation of the first aspect, the method further includes: sending, by the first terminal device to the network device, a first physical uplink control channel (PUCCH) carrying a result of PDSCH processing for the third data.

In a possible implementation of the first aspect, the sending of the first PUCCH starts not earlier than first processing time after an end of a time unit of a physical downlink control channel (PDCCH) carrying the first DCI, or, not earlier than second processing time after the end of the time unit of the PDCCH carrying the first DCI, where the second processing time equals to the first processing time plus a time offset.

In a possible implementation of the first aspect, the sending of the first PUCCH starts not earlier than third processing time after an end of a time unit of a PDSCH scheduled by the second DCI.

PDSCH processing delay is considered for the joint coding between different terminal devices, thus accuracy and reliability of HARQ ACK/NACK feedback can be ensured.

In a second aspect, an embodiment of the present disclosure provides a wireless communication method, where the method includes:
sending, by a network device, a first indication to a first terminal device, where the first indication is indicative of joint coding on a first resource.

Since the joint coding is enabled on the first resource, reliability of data transmitted on the first resource can be improved.

In a possible implementation of the second aspect, the joint coding on the first resource is joint coding for first data for the first terminal device and second data for a second terminal device.

By enabling the joint coding between different terminal devices, not only can the latency and reliability requirements of the second data for the second terminal device be improved, but also the performance of the first terminal device can be ensured.

In a possible implementation of the second aspect, the first data of the first terminal device and the second data of the second terminal device are jointly coded into a first codeword; where the first codeword includes a plurality of encoded blocks generated by encoding the first data and the second data with an error correction code, and the plurality of encoded blocks include a self-decodable encoded block corresponding to the second data, where the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

Multiple decoding attempts are allowed, and thus a success rate of decoding of the first data and the second data and reliability thereof can be improved and a code rate can be reduced, resulting in an improved performance.

In a possible implementation of the second aspect, the first indication is carried in first downlink control information (DCI); where the first DCI is indicative of at least one of: a coding rate of the first data, a coding rate of the second data, resource information of the second data, a code block index of the first data.

In a possible implementation of the second aspect, the first DCI is indicative of the first resource in a reference resource region by at least one of: an M-by-N time-frequency bitmap corresponding to the reference resource region, where M and N are integers greater than 0; an index in a resource allocation table corresponding to the reference resource region; a resource location of the first resource in the reference resource region; where the reference resource region is configured through a radio resource control (RRC) signaling or predefined.

Indication of the first resource used for the joint coding can be flexible.

In a possible implementation of the second aspect, a first radio network temporary identifier (RNTI) is used for scrambling a physical downlink shared channel (PDSCH) for the first data and the second data.

In a possible implementation of the second aspect, the first RNTI is different from a cell-radio network temporary identifier (C-RNTI) of the first terminal device, and the first RNTI is different from a C-RNTI of the second terminal device.

The first RNTI (i.e., mixed RNTI) is proposed to support the joint coding between different terminal devices, so as to be distinguish from, and be better compatible with, other types of joint coding.

In a possible implementation of the second aspect, the method further includes: sending, by the first terminal device to the network device, a first physical uplink control channel (PUCCH) carrying a result of PDSCH processing for the third data.

In a possible implementation of the second aspect, the sending of the first PUCCH starts not earlier than first processing time after an end of a time unit of a physical downlink control channel (PDCCH) carrying the first DCI, or, not earlier than second processing time after the end of the time unit of the PDCCH carrying the first DCI, where the second processing time equals to the first processing time plus a time offset.

In a possible implementation of the second aspect, the sending of the first PUCCH starts not earlier than third processing time after an end of a time unit of a PDSCH scheduled by the second DCI.

PDSCH processing delay is considered for the joint coding between different terminal devices, thus accuracy and reliability of HARQ ACK/NACK feedback can be ensured.

In a third aspect, an embodiment of the present disclosure provides a wireless communication method, where the method includes:
receiving, by a second terminal device, third DCI from a network device, where the third DCI is indicative of joint coding on a first resource.

Since the joint coding is enabled on the first resource, reliability of data transmitted on the first resource can be improved.

In a possible implementation of the third aspect, the joint coding on the first resource is joint coding for first data for a first terminal device and second data for the second terminal device.

By enabling the joint coding between different terminal devices, not only can the latency and reliability requirements of the second data for the second terminal device be improved, but also the performance of the first terminal device can be ensured.

In a possible implementation of the third aspect, the first data of the first terminal device and the second data of the second terminal device are jointly coded into a first codeword; where the first codeword includes a plurality of encoded blocks generated by encoding the first data and the second data with an error correction code, and the plurality of encoded blocks include a self-decodable encoded block corresponding to the second data, where the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

Multiple decoding attempts are allowed, and thus a success rate of decoding of the first data and the second data and reliability thereof can be improved and a code rate can be reduced, resulting in an improved performance.

In a possible implementation of the third aspect, the third DCI is indicative of at least one of: a coding rate of the first data, a coding rate of the second data, resource information of the second data, a code block index of the first data.

In a possible implementation of the third aspect, feedback on the second data is performed by the second terminal device based on HARQ-related information included in the third DCI, and the HARQ-related information includes feedback resource information and feedback timing information for the second data.

In a possible implementation of the third aspect, a first radio network temporary identifier (RNTI) is used for scrambling a physical downlink shared channel (PDSCH) for the first data and the second data.

In a possible implementation of the third aspect, the first RNTI is different from a cell-radio network temporary identifier (C-RNTI) of the first terminal device, and the first RNTI is different from a C-RNTI of the second terminal device.

In a possible implementation of the third aspect, the first RNTI is indicated in the third DCI or configured through an RRC signaling.

The first RNTI (i.e., mixed RNTI) is proposed to support the joint coding between different terminal devices, so as to be distinguish from, and be better compatible with, other types of joint coding.

In a possible implementation of the third aspect, the third DCI is indicative of whether the joint coding for the second data is enabled.

In a possible implementation of the third aspect, the third DCI is further indicative of whether the first data is for the first terminal device; or, whether the first data is for the first terminal device is configured through an RRC signaling.

In a possible implementation of the third aspect, the method further includes: discarding, by the second terminal device, the first data for the first terminal device.

In a fourth aspect, an embodiment of the present disclosure provides a wireless communication apparatus, the apparatus includes various modules configured to execute the wireless communication method according to the first aspect or any possible implementation of the first aspect.

In a fifth aspect, an embodiment of the present disclosure provides a wireless communication apparatus, the apparatus includes various modules configured to execute the wireless communication method according to the second aspect or any possible implementation of the second aspect.

In a sixth aspect, an embodiment of the present disclosure provides a wireless communication apparatus, the apparatus includes various modules configured to execute the wireless communication method according to the third aspect or any possible implementation of the third aspect.

In a seventh aspect, an embodiment of the present disclosure provides a first terminal device including processing circuitry for executing the wireless communication method according to the first aspect or any possible implementation of the first aspect.

In an eighth aspect, an embodiment of the present disclosure provides a network device including processing circuitry for executing the wireless communication method according to the second aspect or any possible implementation of the second aspect.

In a ninth aspect, an embodiment of the present disclosure provides a second terminal device including processing circuitry for executing the wireless communication method according to the third aspect or any possible implementation of the third aspect.

In a tenth aspect, an embodiment of the present disclosure provides a wireless communication system, including the first terminal device according to the seventh aspect, the second terminal device according to the ninth aspect and the network device according to the eighth aspect.

In an eleventh aspect, an embodiment of the present disclosure provides a computer-readable medium storing computer execution instructions which, when executed by a processor, causes the processor to execute the wireless communication method according to the first aspect or any possible implementation of the first aspect or according to the second aspect or any possible implementation of the second aspect or according to the third aspect or any possible implementation of the third aspect.

In a twelfth aspect, an embodiment of the present disclosure provides a computer program product including computer execution instructions which, when executed by a processor, causes the processor to execute the wireless communication method according to the first aspect or any possible implementation of the first aspect or according to the second aspect or any possible implementation of the second aspect or according to the third aspect or any possible implementation of the third aspect.

The present disclosure provides a wireless communication method and related products. The first terminal device receives the first indication from the network device, where the first indication is indicative of joint coding on the first resource. Since the joint coding is enabled on the first resource, reliability of data transmitted on the first resource can be improved. Further, the first data for the first terminal device and the second data for the second terminal device can be jointly coded on the first resource. After receiving the first indication, the first terminal device can determine that a resource initially scheduled for the first terminal device is used for the joint coding of the first data for the first terminal device and the second data for the second terminal device. In this way, not only can the latency and reliability requirements of the second data for the second terminal device be improved, but also the performance of the first terminal device can be ensured.

### BRIEF DESCRIPTION OF THE DRAWINGS

Reference will now be made, by way of example, to the accompanying drawings which show example embodiments of the present disclosure, and in which:

FIG. 1 is a simplified schematic illustration of a communication system according to one or more embodiments of the present disclosure.

FIG. 2 is a schematic illustration of an example communication system according to one or more embodiments of the present disclosure.

FIG. 3 is a schematic illustration of a basic component structure of a communication system according to one or more embodiments of the present disclosure.

FIG. 4 illustrates a block diagram of a device in a communication system according to one or more embodiments of the present disclosure.

FIG. 5 is a schematic illustration of a 6G multi-service scenario according to one or more embodiments of the present disclosure.

FIG. 6a and FIG. 6b are schematic illustrations of self-decoding and joint-decoding according to one or more embodiments of the present disclosure.

FIG. 7 is a schematic illustration of joint coding according to one or more embodiments of the present disclosure.

FIG. 8 is another schematic illustration of joint coding according to one or more embodiments of the present disclosure.

FIG. 9a and FIG. 9b are schematic diagrams of an example of a pre-emption solution.

FIG. 10 is a schematic flowchart of a wireless communication method according to one or more embodiments of the present disclosure.

FIG. 11 is a schematic flowchart of another wireless communication method according to one or more embodiments of the present disclosure.

FIG. 12 is a schematic flowchart of still another wireless communication method according to one or more embodiments of the present disclosure.

FIG. 13 is a schematic diagram of an example of joint coding between different terminal devices according to one or more embodiments of the present disclosure.

FIG. 14 is a schematic diagram of another example of joint coding between different terminal devices according to one or more embodiments of the present disclosure.

FIG. 15 is a schematic diagram of an example of a reference resource region according to one or more embodiments of the present disclosure.

FIG. 16 is a schematic diagram of an example of buffer management according to one or more embodiments of the present disclosure.

FIG. 17 is a schematic flowchart of yet another wireless communication method according to one or more embodiments of the present disclosure.

FIG. 18a and FIG. 18b are schematic diagrams of examples of PDSCH processing for joint coding according to one or more embodiments of the present disclosure.

FIG. 19 is a schematic flowchart of again another wireless communication method according to one or more embodiments of the present disclosure.

FIG. 20 is a schematic structural diagram of a wireless communication apparatus according to one or more embodiments of the present disclosure.

FIG. 21 is a schematic structural diagram of another wireless communication apparatus according to one or more embodiments of the present disclosure.

### DETAILED DESCRIPTION OF THE ILLUSTRATIVE EMBODIMENTS

In the following description, reference is made to the accompanying figures, which form part of the present disclosure, and which show, by way of illustration, specific aspects of embodiments of the present disclosure or specific aspects in which embodiments of the present disclosure may be used. It is understood that embodiments of the present disclosure may be used in other aspects and include structural or logical changes not depicted in the figures. The following detailed description, therefore, is not to be taken in a limiting sense, and the scope of the present disclosure is defined by the appended claims.

To assist in understanding the present disclosure, examples of wireless communication systems and devices are described below.

### Example Communication Systems and Devices

Referring to FIG. 1, as an illustrative example without limitation, a simplified schematic illustration of a communication system is provided. The communication system 100 includes a radio access network 120. The radio access network 120 may be a next generation (e.g., sixth generation (6G) or later) radio access network, or a legacy (e.g., 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 includes a public switched telephone network (PSTN) 140, the internet 150, and other networks 160.

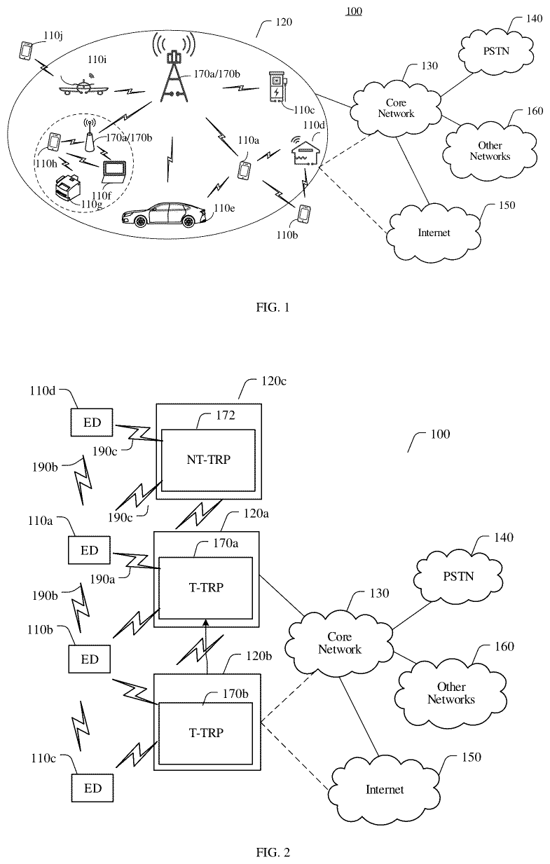

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network including multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. In some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

### Basic Component Structure

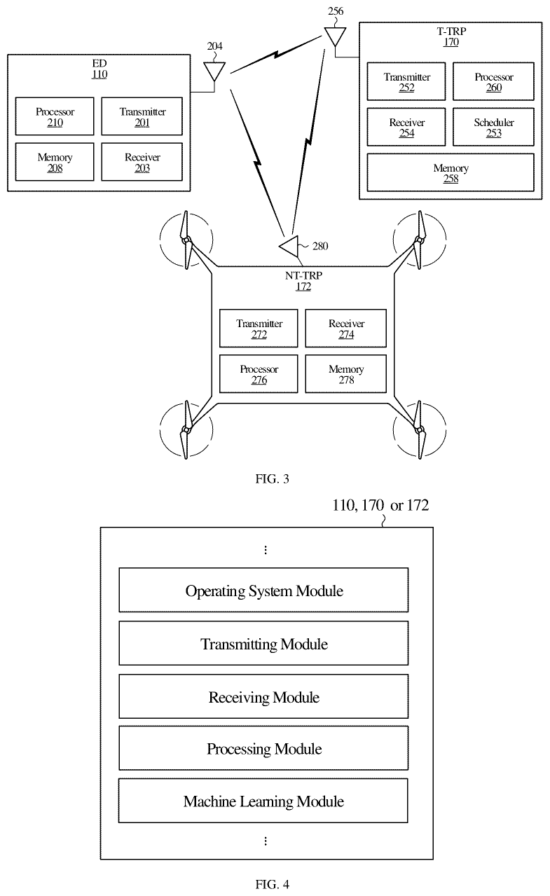

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g., as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g., beam angle information (BAI), received from T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g., in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g., communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g., through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates the indication of beam direction, e.g., BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g., a physical downlink control channel (PDCCH), and static or semi-static higher layer signaling may be included in a packet transmitted in a data channel, e.g., in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g., in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g., MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g., BAI) received from T-TRP 170. In some embodiments, the processor 276 may generate signaling, e.g., to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g., in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

### Basic Module Structure

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

### 6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g., to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g., for use in a 6G network or later. In a flexible frame structure, a symbol block may be defined as the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g., for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g., data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: channel condition (e.g., multi-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cells, Carriers, Bandwidth Parts (BWPs) and Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center or lowest or highest frequency of the carrier. A carrier may be on licensed or unlicensed spectrum. Wireless communication with the device may also or instead occur over one or more BWPs. For example, a carrier may have one or more BWPs. More generally, wireless communication with the device may occur over a wireless spectrum. The spectrum may include one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, e.g., sidelink transmitting and receiving resources.

A BWP may be broadly defined as a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g., a BWP may have a bandwidth of 40 MHz and consists of two adjacent contiguous carriers, where each carrier has a bandwidth of 20 MHz. In some embodiments, a BWP may include non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g., base station) dynamically, e.g., in physical layer control signaling such as DCI, or semi-statically, e.g., in radio resource control (RRC) signaling or in the medium access control (MAC) layer, or be predefined based on the application scenario; or be determined by the UE as a function of other parameters that are known by the UE, or may be fixed, e.g., by a standard.

### Terminal Types

The communication method provided in this embodiment of this disclosure may be applied to various communication scenarios, for example, may be applied to one or more of the following communication scenarios: enhanced mobile broadband (enhanced mobile broadband, eMBB), ultra-reliable low-latency communication (ultra reliable low latency communication, URLLC), and machine type communication (machine type communication). MTC), Internet of Things (IoT), narrowband Internet of Things (narrow band internet of thing, NB-IoT), customer front-end equipment (customer front-end equipment, CPE), augmented reality (augmented reality, AR), virtual reality (virtual reality, VR), mass machine type communications (mMTC), device to device (D2D), vehicle to everything (V2X), vehicle to vehicle (V2V), etc.

It should be noted that in this embodiment of this disclosure, IoT (internet of thing, IoT) may include one or more of NB-IoT, MTC, mMTC, and the like. This is not limited.

The eMBB may be a large-traffic mobile broadband service such as a three-dimensional (three-dimensional, 3D) or ultra-high-definition video. Specifically, the eMBB may further improve performance such as a network speed and user experience based on a mobile broadband service. For example, when a user watches a 4K HD video, the peak network speed can reach 10 Gbit/s.

URLLC may refer to a service with high reliability, low latency, and extremely high availability. Specifically, the URLLC may include the following communications scenarios and applications: industrial application and control, traffic safety and control, remote manufacturing, remote training, remote surgery, unmanned driving, industrial automation, a security industry, and the like.

MTC may refer to a low-cost and coverage-enhanced service, and may also be referred to as M2M. mMTC refers to large-scale IoT services.

NB-IoT may be a service that features wide coverage, a large number of connections, a low rate, a low cost, low power consumption, and an excellent architecture. Specifically, the NB-IoT may include a smart water meter, smart parking, intelligent pet tracking, a smart bicycle, an intelligent smoke detector, an intelligent toilet, an intelligent vending machine, and the like.

The CPE may refer to a mobile signal access device that receives a mobile signal and forwards the mobile signal by using a wireless fidelity (wireless fidelity, WiFi) signal, or may refer to a device that converts a high-speed 4G or 5G signal into a WiFi signal, and may simultaneously support a relatively large quantity of mobile terminals that access the Internet. CPEs can be widely used for wireless network access in rural areas, towns, hospitals, units, factories, and residential areas, reducing the cost of laying wired networks.

The V2X can enable communication between vehicles, between vehicles and network devices, and between network devices, to obtain a series of traffic information such as a real-time road condition, road information, and pedestrian information, and provide in-vehicle entertainment information to improve driving safety, reduce congestion, and improve traffic efficiency.

For example, the terminal type includes an eMBB device, a URLLC device, an NB-IoT device, and a CPE device. The eMBB device is mainly configured to transmit large-packet data, or may be configured to transmit small-packet data, and is generally in a moving state. Requirements for a transmission delay and reliability are general, and both uplink and downlink communication exists. A channel environment is relatively complex and changeable, and indoor communication or outdoor communication may be used. For example, an eMBB device may be a mobile phone. The URLLC device is mainly configured to transmit small packet data, or may transmit medium packet data. Generally, the URLLC device belongs to a non-moving state, or may move along a fixed route. The URLLC device has a relatively high requirement for a transmission delay and reliability, that is, a low transmission delay and high reliability are required, and both uplink and downlink communications have. The channel environment is stable. For example, the URLLC device may be a factory device. The NB-IoT device is mainly used to transmit small data. The NB-IoT device is generally in a non-moving state, has a known location, has a medium transmission delay and reliability requirement, has a relatively large amount of uplink communication, and has a relatively stable channel environment. For example, the NB-IoT device may be a smart water meter or a sensor. The CPE device is mainly used to transmit large-packet data, is generally in a non-mobile state, or can move over ultra-short distances, has medium requirements on transmission delay and reliability, has both uplink and downlink communication, and has a relatively stable channel environment. For example, The CPE device may be a terminal device, an AR, a VR, or the like in the smart home. When the terminal type of the terminal device is determined, the terminal type may be determined based on a service type, mobility, a transmission delay requirement, a reliability requirement, a channel environment, and a communication scenario of the terminal device. Determining that the terminal type corresponding to the terminal device is an eMBB device, a URLLC device, an NB-IoT device, or a CPE device.

It should be noted that the eMBB device may alternatively be described as eMBB, the URLLC device may alternatively be described as URLLC, the NB-IoT device may alternatively be described as NB-IoT, and the CPE device may alternatively be described as CPE. The V2X device may also be described as a V2X device, which is not limited.

### Physical Uplink Control Channel (PUCCH) and Physical Transmit Link Control Channel (PTxCCH)

A physical uplink control channel (physical uplink control channel, PUCCH) is mainly used to carry uplink control information (uplink control information, UCI). Specifically, the information may include information about applying for an uplink resource configuration by the terminal device from the network device, information about replying whether the downlink service data is correctly received by the terminal device, and channel state information (channel state information, CSI) of the downlink channel reported by the terminal device.

In a possible implementation, a physical layer control channel, that is, a physical transmission link control channel (physical transmission link control channel, PTxCCH), may be introduced. A function of the PTxCCH is similar to that of a PUCCH in LTE and 5G. Specifically, the channel is used by the terminal device to transmit control information, and/or is used by the network device to receive control information. The control information may include at least one of the following: ACK/NACK information, channel state information, a scheduling request, and the like. It should be understood that, generally, the standard protocol is described from a perspective of a terminal device. Therefore, the physical layer uplink control channel may be described as a physical layer transmit link control channel.

### Downlink Control Information (DCI)

Downlink control information (DCI) is control information that is transmitted on a PDCCH and that is related to a PDSCH and a PUSCH. The terminal device can correctly process the PDSCH data or the PUSCH data only when the DCI information is correctly decoded.

Uses of different DCI may be different, for example, DCI used for uplink/downlink transmission resource allocation, DCI used for uplink power control adjustment, and DCI used for downlink dual-stream spatial multiplexing. Different DCI formats may be used for differentiation of DCI for different purposes.

Specifically, the information included in the DCI may be classified into three types, and the DCI may include at least one of the three types. The first-type information is information used for channel estimation, for example, a time-frequency resource indication or a demodulation reference signal (demodulation reference signal, DMRS). The second type of information is information used to decode the PDSCH, for example, a modulation and coding scheme (modulation and coding scheme, MCS), a hybrid automatic repeat request process number (hybrid automatic repeat request process number, HARQ process number), and a new data indicator (new data indicator, NDI). The third type of information is information used to send UCI, for example, a PUCCH resource, transmit power control (Transmit power control, TPC), code block group transmission information (Code block group transmission information, CBG) configuration, and channel state information (Channel state information). CSI) trigger information, sounding reference signal (Sounding reference signal, SRS) trigger information, and the like.

To reduce a quantity of blind detection times of the terminal device, it is proposed that information included in the DCI is transmitted in parts. For example, the first type information is used as the first DCI for transmission, the second type information is used as the second DCI for transmission, and the third type information is used as the third DCI for transmission. Alternatively, for another example, the first-type information and the second-type information are used as first DCI for transmission, and the third-type information is used as second DCI for transmission. Alternatively, for another example, the first type information is used as the first DCI for transmission, and the second type information and the third type information are used as the second DCI for transmission. The information included in the DCI is transmitted in parts, so that the terminal device can process different types of information in parallel, thereby reducing a communication delay.

### Blind Detection of Terminal Devices

Because the terminal device does not know in advance which format DCI is carried on the received PDCCH, and does not know which candidate PDCCH is used to transmit the DCI, the terminal device must perform PDCCH blind detection to receive corresponding DCI. Before the terminal device successfully decodes the PDCCH, the terminal device may attempt to decode each possible candidate PDCCH until the terminal device successfully detects the PDCCH, or a quantity of DCI expected to be received by the terminal device or a quantity of blind detection times limit of the terminal device is reached.

In other words, the DCI has a plurality of different formats. When receiving the PDCCH, the terminal device cannot determine a DCI format to which the received DCI belongs, and therefore cannot correctly process data transmitted on a channel such as a PDSCH or a PUSCH. Therefore, the terminal device must perform blind detection on a format of the DCI. Generally, the terminal device does not know a format of the current DCI, and does not know a location of information required by the terminal device. However, the terminal device knows information in a format expected by the terminal device, and expected information in different formats corresponds to different expected RNTIs and CCEs. Therefore, the terminal device may perform CRC check on the received DCI by using the expected RNTI and the expected CCE, so as to know whether the received DCI is required by the terminal device, and also know a corresponding DCI format and a corresponding modulation scheme, so as to further access the DCI. The foregoing procedure is a blind detection process of the terminal device.

It should be understood that, a cyclic redundancy check (cyclic redundancy check, CRC) bit is usually added to the information bits of the DCI to implement an error detection function of the terminal device, and different types of radio network identifiers (radio network temporary identifier, RNTI) are used for scrambling in the CRC bits. Thus, the RNTI is implicitly encoded in the CRC bits. It should be further understood that different RNTIs can be used to both identify the terminal device and distinguish purposes of the DCI.

In addition, for a blind detection process of the terminal device, because the PDCCH includes a plurality of CCEs, or DCI is carried on the plurality of CCEs, the terminal device needs to perform blind detection on the plurality of CCEs. However, if the terminal device performs blind detection one by one at a granularity of CCEs, efficiency is relatively low. Therefore, a search space (search space) is specified in a protocol. The search space may be simply understood as that when the terminal device performs PDCCH blind detection, blind detection is performed by using several CCEs as a granularity. For example, if a value of an aggregation level AL of a CCE defined in the search space is 4 or 8, when the terminal device performs blind detection, Blind detection is performed at a granularity of four CCEs and then at a granularity of eight CCEs.

Specifically, when the value of the aggregation level AL of the CCE defined in the search space is 4 or 8, when the network device identifies the PDCCH, in addition to using the aggregation level parameter (a value of 4 or 8 is selected). A CCE location index (CCE index) parameter is further used, where the CCE location index is obtained through calculation based on time-frequency domain information of the PDCCH, an aggregation level, and the like. Because the terminal device cannot accurately know the aggregation level of the CCE occupied by the PDCCH and the start location index of the CCE, the terminal device receives higher layer signaling before receiving the PDCCH, where the higher layer signaling indicates time-frequency domain information of the PDCCH, and the like. In addition, the terminal device determines, based on a protocol, an indication of a network device, or the like, that the aggregation level of the PDCCH may be 4, or may be 8. Therefore, during blind detection, the terminal device may first use the aggregation level 4 and based on the time-frequency domain information of the PDCCH, calculating a position index (including a start position index of a CCE) of the CCE in the PDCCH, and performing blind detection on a corresponding CCE; and; Then, when the expected DCI is not detected or the quantity of DCI that is not expected to be detected reaches, the terminal device may further use the aggregation level 8 and based on the time-frequency domain information of the PDCCH, calculating a start position index (the position index of the CCE) of the CCE in the PDCCH, and performing blind detection on the corresponding CCE.

### Downlink (DL) HARQ and Uplink (UL) HARQ

For DL HARQ, a MAC (media access control) entity includes a HARQ entity for each serving cell, which maintains a number of parallel HARQ processes. Each HARQ process is associated with a HARQ process identifier (ID). The HARQ entity directs HARQ information and associated TBs (Transport Blocks) received on a DL-SCH (DL Shared CHannel) to the corresponding HARQ processes. The HARQ process supports one TB when the physical layer is not configured for downlink spatial multiplexing, and the HARQ process supports one or two TBs when the physical layer is configured for downlink spatial multiplexing. When a transmission takes place for the HARQ process, one or two (in case of downlink spatial multiplexing) TBs and the associated HARQ information are received from the HARQ entity.

For UL HARQ, a MAC entity includes a HARQ entity for each serving cell with configured uplink, which maintains a number of parallel HARQ processes. Each HARQ process supports one TB, and each HARQ process is associated with a HARQ process identifier (ID). Each HARQ process is associated with a HARQ buffer.

The above describes possible scenarios or generalized description of the embodiments of the present disclosure, the motivation and technical concepts of the present disclosure are illustrated in the following.

Resilience is a fundamental feature that needs to be addressed in 6G. With the evolution of Industry 4.0 and many other technology visions, ultra-reliable and low latency wireless communications are pivotal enabler for automated manufacturing on a massive scale.

Two trends are observed toward 6G. From the technological perspective, mmWave and massive MIMO (Multiple-Input Multiple-Output) will be more prevalent because they can significantly expand the current bandwidth resource. From the service perspective, a single device will need to support multiple services with different latency and reliability requirements. The two trends, together with the more stringent resilience requirement, provides an opportunity to re-design the physical layer.

A potential scenario emerges as multiple services converges into one physical wireless link. The purpose is to deliver multiple QoS (Quality of Service) to multiple services within only one wireless link. Given the high carrier frequency and massive antennas, beamforming can be done more aggressively, enabling the convergence of multiple services in one wireless link. Meanwhile, these services may have very diverse KPIs (Key Performance Indicators). As shown in FIG. 5, URLLC (Ultra-Reliable Low-Latency Communications), mMTC (massive Machine Type Communication), eMBB (enhanced Mobile Broadband) and Tbps communications may all be integrated in one beam. This is challenging because different KPIs must be supported under the same wireless channel, SNR (Signal to Interference plus Noise Ratio), fading, etc.

For two packets with different payload size and/or reliability/latency requirement, e.g., one eMBB packet with large payload size and another URLLC packet with small payload size and/or with higher reliability requirement, joint coding (or called mixed traffic coding) could be used for the two packets.

### Joint Coding (or Called Mixed Traffic Coding)

Joint coding refers to jointly encoding multiple packets (more than 1) into one codeword, e.g., jointly encoding a small packet (e.g., a URLLC packet) and a large packet (e.g., an eMBB packet) into one codeword. That is to say, there are multiple payloads in a joint codeword. For the joint encoding, there are two possible solutions:
Solution 1: encode multiple payloads into one codeword, where at least one payload is self-decodable (locally decodable) and global decodable.
Solution 2: encode multiple payloads into one codeword with unequal error protection.

For Solution 1, a self-decodable joint coding design is given, such that each individual payload (e.g., corresponding to a service) can be self-decoded, and at the same time joint decoding is supported to further enhance performance. Small messages (e.g., URLLC bits) are both locally and globally decodable, and a larger code block (e.g., containing eMBB bits) can be globally decodable. Specifically, local decoding is used as first attempt (lower reliable). If the local decoding succeeded, the small code can be used for enhancing the larger code since the correctly received small code provides prior information for the decoding of the larger code. If the local decoding failed, global decoding with the larger code is used as second attempt (higher reliable), that is, in the second attempt, the small code can be globally decoded (jointly decoded) with the larger code.

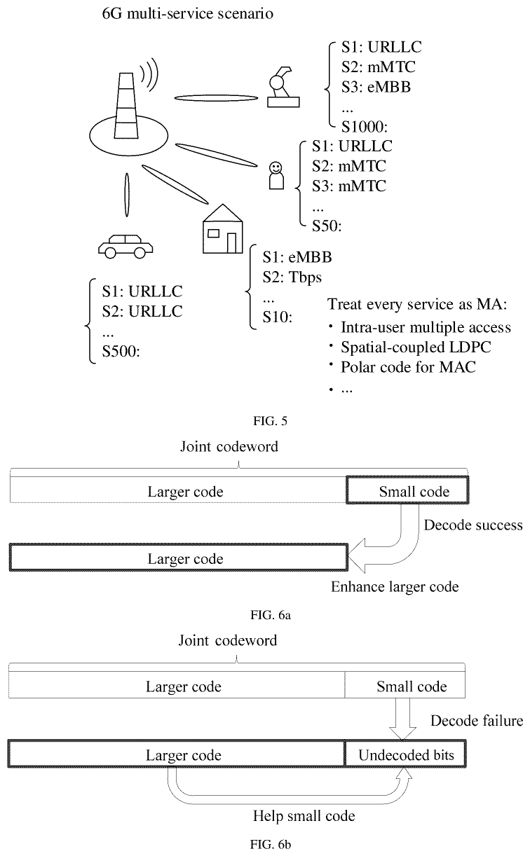

FIG. 6a and FIG. 6b are an illustration of self-decoding and joint-decoding (in the event of a self-decoding failure). As an example, several smaller or shorter messages may be embedded or otherwise combined into a longer code block or payload, also referred to herein as a combined payload. These smaller messages are self-decodable, meaning that they can be decoded after collecting only a subset of code bits, or symbols, or LLRs, associated with a longer codeword rather than the entire, longer codeword. The subset of code bits is also a standalone short code or codeword that is decodable on its own.

Two or more of such smaller messages are also jointly-decodable. The subsets of code bits corresponding to smaller messages that are jointly-decodable combine into a longer code. This may be accomplished through what is referred to herein as “coupling” between bits from multiple messages. For example, some or all of the bits of a first message (small code) may be copied and combined with bits of a second message (larger code). In this example, bits from the first message may be directly copied and appended to or otherwise combined with the bits of the second message. Another possible option is to first transform bits from the first message, by multiplying them with a binary matrix for example, and then appending the transformed bits to, or otherwise combining the transformed bits with, the bits of the second message.

Although this example refers to information bit (message) coupling, it is feasible to also or instead use coded bits for coupling. In the case of systematic codes, for example, message bits are also part of code bits, and thus the two alternatives, for information bit coupling or code bit coupling, become much the same.

Some embodiments support multiple decoding attempts before requesting retransmission. Joint decoding, for example, may in effect be inserted or attempted between a decoding failure and a retransmission request. As an example, consider an embodiment that involves a three decoding attempt transmission approach. Referring to FIG. 6a and FIG. 6b, in a first decoding attempt, a receiver receives a codeword and decodes a first self-decodable payload of the codeword after receiving a corresponding minimum of required code bits. If the decoding of the first payload is successful (FIG. 6a), then the correctly decoded bits can be used to enhance decoding performance for a second payload of the codeword, after a corresponding minimum required number of code bits for decoding of the second payload are received. A second decoding attempt is made if decoding of the first payload fails (FIG. 6b). Instead of immediately requesting a retransmission, the receiver instead proceeds to attempt to jointly decode the first payload with the second payload. After decoding of the second payload, regardless of whether there is success or failure of the second payload decoding, joint decoding can increase probability that the first payload will be successfully decoded. In this example, if decoding of the first payload still fails after the second (joint) decoding attempt, then the receiver requests a retransmission (not shown) from the transmitter. This will incur some delay, but with a retransmission the receiver can make at least a third decoding attempt. With a retransmitted codeword, multiple decoding attempts may further be made, to self-decode from the retransmitted codeword, jointly decode from parts of the retransmitted codeword, and/or jointly decode using both the previously received codeword and the retransmitted codeword.

By adopting the above solution, since some or all of the bits of the small code are copied and combined with bits of the larger code due to the joint coding, on one hand, after a successful decoding of a self-decodable code, the code rate of at least another code (e.g., eMBB bits) can be reduced, therefore resulting in an improved performance. That is, an augmented eMBB is achieved. On the other hand, if a self-decodable code (e.g., URLLC) fails to decode, instead of requesting a retransmission, the receiver proceeds to jointly decode the self-decodable code with the lager code. If the joint decoding is successfully, the code rate of the former can be reduced, resulting in an improved performance. That is, HARQ-less URLLC is achieved.

For Solution 2, a small URLLC packet is embedded to an eMBB packet. In short, the concept is one single FEC (Forward Error Correction) for multiple packets. In the encoder design, the priority order of the packets is taken into account, ensuring better protection for the packet with higher priority. Priority can be defined with different metrics, such as a reliability priority in terms of target BLER (Block Error Ratio), a latency priority in terms of latency requirement, a source priority where packets may come from different sources, e.g., in relay and multi-hop scenarios.

The solution may use separate CRC to allow individual packet decoding. When a packet fails to be decoded, the HARQ scheme would request a retransmission of the joint codeword.

Solution 2 can be regarded as “priority-based payload mapping”. FIG. 7 is a schematic illustration of joint coding of Solution 2. Specifically, as shown in FIG. 7, payload data (or packets) can be from different applications (or different sources). First, they are grouped by their QoS requirements and are CRC encoded separately. Then, a priority-based payload mapping procedure is performed to map each packet onto the information bit positions of a codeword according to reliability or latency. The reliability or latency of each bit depends on the specific channel coding scheme and decoding algorithms. FIG. 7 shows joint coding of two packets, i.e., an URLLC payload and an eMBB payload. In practice, there may be more than two packets jointly coded.

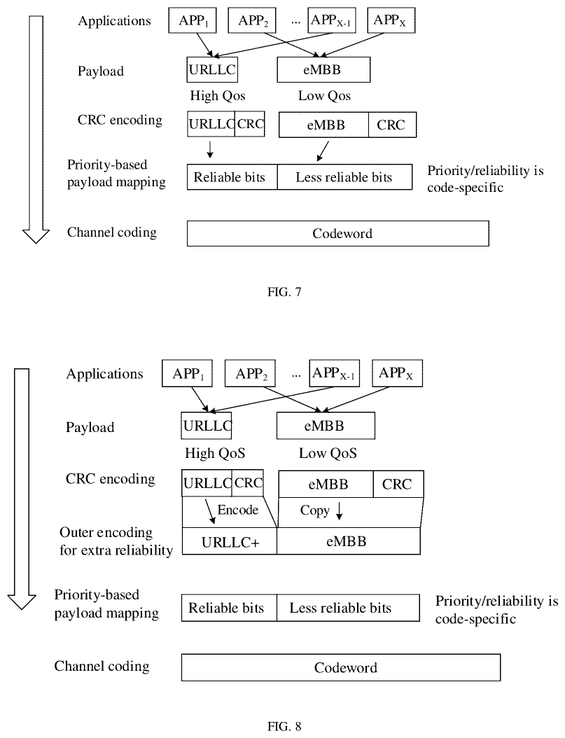

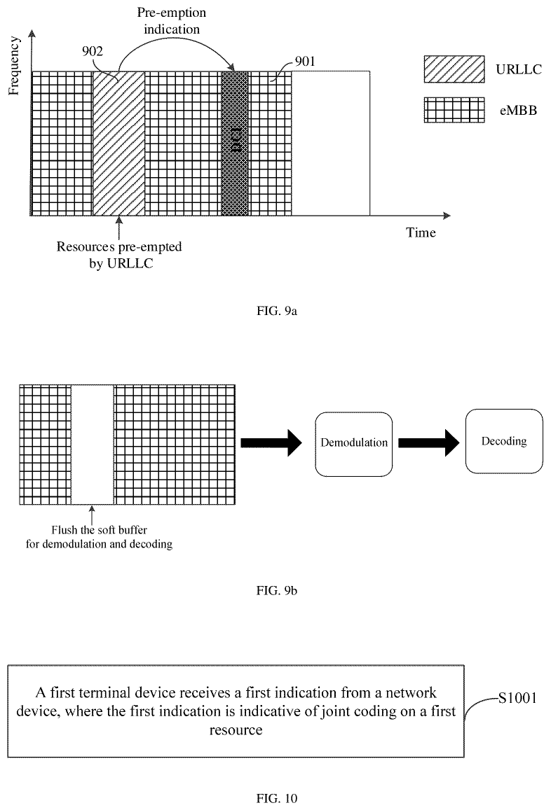

A possible enhancement of the above solution is to additionally protect the URLLC payload with an outer code. FIG. 8 is a schematic illustration of joint coding with the possible enhancement. This can achieve extra reliability for the URLLC payload. This is done by inserting another encoding process between CRC encoding and priority-based mapping, as shown in FIG. 8.

In the present disclosure, details on air interface designs for joint coding will be given, and the proposed air interface designs for join coding can be used in both of the above solutions.

### Pre-Emption Solution

According to some embodiments of the present disclosure, for multiplexing of two kinds of service data in NR, such as multiplexing of URLLC data and eMBB data, in order to enable latency and reliability requirements of one of them (e.g., the URLLC data), a pre-emption solution is proposed. The URLLC data and the eMBB data will be taken as an example of the two kinds of service data in the following description of the pre-emption solution.

The pre-emption solution allows URLLC data for a URLLC terminal device to use resources scheduled for eMBB data for an eMBB terminal device. FIG. 9a and FIG. 9b shows a schematic diagram of an example of a pre-emption solution. As shown in FIG. 9a, a resource 901 is scheduled by a network device for the eMBB data for the eMBB terminal device at first. When the URLLC data for the URLLC terminal device arrives, in order to enable the latency and reliability requirements of the URLLC data, the network device may schedule the URLLC data for the URLLC terminal device to use a resource 902 in the resource 901 scheduled for the eMBB data. Then the network device can send an indication to the eMBB terminal device to tell that which part of the resource 901 is used by the URLLC terminal device, that is, to tell that which part of resources is pre-empted by the URLLC terminal device. Specifically, a pre-emption indicator (e.g., being carried in DCI) may be sent in the next slot to indicate which part of the scheduled resource (i.e., the resource 902 in this example) is occupied by the URLLC terminal device. After receiving the pre-emption indicator, as shown in FIG. 9b, the eMBB terminal device will flush a soft buffer of data on the pre-empted resource 902, and then perform demodulation and decoding.

In this way, the latency and reliability requirements of the URLLC data can be ensured.

Further, since the part of the eMBB data on the pre-empted resource 902 is not transmitted in the above embodiments, the eMBB terminal device sometimes may not decode the whole eMBB data correctly, and thus the eMBB data may need to be retransmitted, thereby affecting eMBB performance.

The present disclosure further provides solutions for improving the performance of the above pre-emption solution.

According to a concept of the present disclosure, a first terminal device may receive a first indication from a network device, and the first indication is indicative of joint coding on a first resource. Since the joint coding is enabled on the first resource, reliability of data transmitted on the first resource can be improved. Further, first data for the first terminal device and second data for a second terminal device may be jointly coded on the first resource. After receiving the first indication, the first terminal device can determine that a resource initially scheduled for the first terminal device is used for the joint coding of the first data for the first terminal device and the second data for the second terminal device. In this way, not only can the latency and reliability requirements of the second data for the second terminal device be improved, but also the performance of the first terminal device can be ensured.

The above briefly describes some technical concepts of the present disclosure, and then specific embodiments of the present disclosure will be elaborated in the following description.

FIG. 10 shows a schematic flowchart of a wireless communication method according to one or more embodiments of the present disclosure. The method can be implemented by a first terminal device. As shown in FIG. 10, the method can include:
S1001, a first terminal device receives a first indication from a network device, where the first indication is indicative of joint coding on a first resource.

The first terminal device receives the first indication from the network device, and the first indication may be indicative of joint coding on the first resource. In an implementation, the joint coding on the first resource may be enabled for multiple data portions. From the perspective of a source of the multiple data portions, the multiple data portions subject to the joint coding may be from different services, for example, a data portion may be URLLC data, and another data portion may be eMBB data, etc. The multiple data portions may also be from the same service. From the perspective of a destination of the multiple data portions, in an implementation, all of the multiple data portions are for the first terminal device. In another implementation, depending on scheduling by the network device, the multiple data portions may be for different terminal devices, and at least one of the data portions is for the first terminal device.

In an implementation, the multiple data portions may include first data and second data, and the joint coding on the first resource may be joint coding for the first data and the second data. In an implementation, Solution 1 or Solution 2 of the joint coding as described above may be applied for the joint coding here, in which the first data may be the eMBB data of Solution 1 and Solution 2 and the second data may be the URLLC data of Solution 1 and Solution 2. In a specific implementation, information bits of the first data and information bits of the second data may be multiplexed in a MAC layer and then encoded, which also enables joint coding.

It should be noted that the solutions of the present disclosure can be applied to specific solutions where the first data (payload) and the second data (payload) are jointly coded, and can also be applied to specific solutions where a first MAC PDU (Protocol Data Unit) and a second MAC PDU are jointly coded. In the following, implementations for the specific solutions where the first data and the second data are jointly coded will be described as examples, and it should be noted that they could also be applied to the specific solutions where the first MAC PDU and the second MAC PDU are jointly coded.

In an implementation, the first data may be for the first terminal device and the second data may be for a second terminal device. That is, the joint coding between different terminal devices is enabled in this implementation, and the joint coding between different terminal devices may also be called inter-UE joint coding or inter-UE mixed traffic cooperation. In an example, the first data may be eMBB data, and the second data may be URLLC data.

In an implementation, the first data of the first terminal device and the second data of the second terminal device are jointly coded into a first codeword. For example, the second data may be jointly coded with a part of the first data or jointly coded with the whole first data, to form the first codeword including the first data and the second data. As for which part of the first data is jointly coded with the second data, it may be configured (e.g., through an RRC signaling) or predefined, or may be indicated by the network device. The first codeword includes a plurality of encoded blocks generated by encoding the first data and the second data with an error correction code, and the plurality of encoded blocks include a self-decodable encoded block corresponding to the second data. The self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword. In other words, the second data may be self-decodable, and the second data may be jointly-decodable according to a self-decoding result of the second data.

In an implementation, the first indication indicative of the joint coding on the first resource may be carried in first DCI. The first DCI may be indicative of resource information (e.g., time/frequency/spatial resources, RE portion, RE location, etc.) and decoding information (e.g., MCS, DMRS, etc.) of the first data and the second data. For example, the first DCI is indicative of at least one of: a coding rate of the first data, a coding rate of the second data, resource information of the second data, a code block index of the first data. Optionally, the first DCI may be further indicative of HARQ-related information (HARQ process ID, NDI, RV, feedback resource information, feedback timing information, etc.) and other information for the first data.

In an implementation, the first terminal device receives the first data and the second data that are subject to the joint coding from the network device on a PDSCH. A first radio network temporary identifier (RNTI) is used for scrambling the PDSCH. In a specific implementation, since the joint coding is enabled for different terminal devices (i.e., the first terminal device and the second terminal device), the first RNTI (which may be called a joint RNTI or a mixed RNTI) may be different from a cell-radio network temporary identifier (C-RNTI) of the first terminal device and different from a C-RNTI of the second terminal device. Optionally, the first RNTI may be indicated in the first DCI or configured through an RRC signaling.

The above solutions of the embodiments of the present disclosure may be applied to a scenario with a pre-emption solution.

According to a pre-emption solution in some embodiments, the network device may initially schedule a resource for third data (e.g., eMBB data) for the first terminal device. When the second data (e.g., URLLC data) for the second terminal device arrives, the network device schedules the second data for the second terminal device to use a part of the resource initially scheduled for the third data (also referred to as a second resource or pre-empted resource). That is, the part of the resource initially scheduled for the third data is pre-empted by the second terminal device to ensure the latency and reliability requirements of the URLLC data. Here the resource actually occupied by the URLLC data may not be limited to be as same as the second resource in size. In this case, data initially scheduled for the first terminal device on the pre-empted resource is not transmitted, instead, the second data for the second terminal device is transmitted on the pre-empted resource. Thus, the first terminal device sometimes may not be able to decode the received data correctly, thereby affect performance of the first terminal device.

According to some other embodiments of the present disclosure, when the second data (e.g., URLLC data) for the second terminal device arrives, the network device may determine to allow a second resource in the resource initially scheduled for the third data to be “pre-empted”. Instead of using the pre-empted second resource to transmit the second data without transmitting the data that is initially scheduled to be transmitted on the second resource, according to these embodiments of the present disclosure, the network device enables the joint coding of the second data for the second terminal device and the first data of the third data for the first terminal device. The network device may schedule the first resource to be used for jointly coded data (i.e., the first codeword) of the second data and the first data. In an implementation, the first resource includes the second resource. That is, the second resource that is initially scheduled for the third data is now used for the jointly coded data. In other words, the second resource is an overlapped resource between the resource initially scheduled for the third data and the first resource.

After receiving the first indication indicative of the joint coding on the first resource (e.g., in the next scheduling period or in the next PDCCH monitoring occasion, such as in the next slot), the first terminal device can determine that the second resource initially scheduled for the third data overlaps with at least part of the first resource. Then the first terminal device can determine that data initially scheduled on the second resource is not transmitted by the network device and that the jointly coded data including the first data and the second data are transmitted on the first resource including the second resource. At this time, the first terminal device can perform decoding on the received data to obtain the third data and the second data. In a specific implementation, the first terminal device may combine the first data from the jointly coded data and data received on the initially scheduled resource other than the second resource to obtain the combined third data. In this implementation, since the second data is for the second terminal device, the first terminal device can discard the second data.

It should be noted that embodiments and examples herein are described by taking joint coding for two kinds of traffic data as examples, which may also be called mixed traffic coding. However, the present disclosure is not limited thereto, for example, the solutions of the present disclosure may also be applied to joint coding for more than two kinds of traffic data, or joint coding for different control information, or joint coding for control information and traffic data.

With the wireless communication method provided by the present disclosure, the first terminal device receives the first indication from the network device, where the first indication is indicative of joint coding on the first resource. Since the joint coding is enabled on the first resource, reliability of data transmitted on the first resource can be improved. Further, the first data for the first terminal device and the second data for the second terminal device can be jointly coded on the first resource. After receiving the first indication, the first terminal device can determine that a resource initially scheduled for the first terminal device is used for the joint coding of the first data for the first terminal device and the second data for the second terminal device. In this way, not only can the latency and reliability requirements of the second data for the second terminal device be improved, but also the performance of the first terminal device can be ensured.

In the above, the wireless communication method of the present disclosure is described from the perspective of the first terminal device in combination with FIG. 10. In the following, a wireless communication method of the present disclosure will be described from the perspective of a network device in combination with FIG. 11. FIG. 11 shows a schematic flowchart of another wireless communication method according to one or more embodiments of the present disclosure. The method can be implemented by a network device. As shown in FIG. 11, the method can include:
S1101, a network device sends a first indication to a first terminal device, where the first indication is indicative of joint coding on a first resource.

For S1101, reference may be made to the description for S1001, which will not be repeated here.

With the wireless communication method provided by the present disclosure, the network device sends the first indication to the first terminal device, where the first indication is indicative of joint coding on the first resource. Since the joint coding is enabled on the first resource, reliability of data transmitted on the first resource can be improved. Further, the first data for the first terminal device and the second data for the second terminal device can be jointly coded on the first resource. That is, a resource initially scheduled for the first terminal device is used for the joint coding of the first data for the first terminal device and the second data for the second terminal device. In this way, not only can the latency and reliability requirements of the second data for the second terminal device be improved, but also the performance of the first terminal device can be ensured.

In order to elaborate the wireless communication methods of the present disclosure more clearly, in the following, taking the first data and the third data being eMBB data and the second data being URLLC data as an example, the method will be described in more details. In the following, details on the joint coding between different terminal devices (i.e., inter-UE joint coding) will be given for illustration, and it should be noted that they may also be applicable to other types of joint coding, e.g., regular joint coding (simply scheduling jointly coded data for one time), intra-UE joint coding (e.g., scheduling non-jointly coded data for the first time for a terminal device, and then scheduling jointly coded data for the second time for the terminal device, the two times of scheduling having overlapped resources), etc.

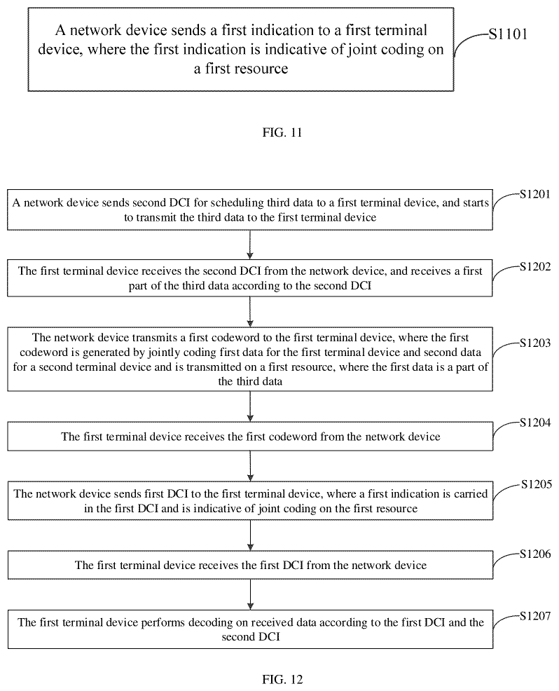

FIG. 12 is a schematic flowchart of still another wireless communication method according to one or more embodiments of the present disclosure. This method includes the following steps.

S1201, a network device sends second DCI for scheduling third data to a first terminal device, and starts to transmit the third data to the first terminal device.

S1202, the first terminal device receives the second DCI from the network device, and receives a first part of the third data according to the second DCI.

The network device may send the second DCI to the first terminal device. The second DCI is used for scheduling the third data. The second DCI may schedule one TB or multiple TBs for the third data. Each TB may correspond to one or multiple CBs (code blocks). The second DCI may be indicative of scheduling information of the third data, and the scheduling information of the third data may include resource information (e.g., time/frequency/spatial resources, RE portion, RE location, etc.) and decoding information (e.g., MCS, DMRS, etc.) of the third data. Optionally, the scheduling information for the third data may also include HARQ-related information (HARQ process ID, NDI, RV, feedback resource information, feedback timing information, etc.) and other information (such as measurement indication, power control indication) for the third data. In a specific implementation, the resource information of the third data may include a resource scheduled for the third data for the first terminal device, which may also be called the resource initially scheduled for the third data.

The network device starts to transmit the third data to the first terminal device, and the first terminal device starts to receive the third data. Then a pre-emption scenario may be considered as an example. For example, the first terminal device receives the first part of the third data and then a need of pre-emption emerges. For instance, one TB is scheduled for the third data, and the one TB may correspond to N+1 CBs, namely, CB0 to CBN (i.e., the n-th CB). The first part of the third data may be CB0 and CB1 of the third data.

It should be noted that the execution order of S1201 and S1202 is only illustrative and is not limited in the present disclosure. For example, it may be that the network device sends the second DCI to the first terminal device, and the first terminal device receives the second DCI from the network device. Then the network device starts to transmit the third data to the first terminal device, and the first terminal device starts to receive the third data according to the second DCI.

S1203, the network device transmits a first codeword to the first terminal device, where the first codeword is generated by jointly coding first data for the first terminal device and second data for a second terminal device and is transmitted on a first resource, where the first data is a part of the third data.

S1204, the first terminal device receives the first codeword from the network device.

Continuing with the pre-emption scenario as an example, after the first terminal device receives the first part of the third data, the second data for the second terminal device may arrive. The network device may determine to allow a second resource in the resource initially scheduled for the third data to be pre-empted. In an example, the first data may be data of the third data which is to be transmitted after the first part of the third data. In an implementation, the first data may include one or multiple CBs. For example, the second data may be jointly encoded with one or multiple CBs (i.e., the first data) of the third data, which can be configured or predefined. For instance, in a case that the first part of the third data is CB0 and CB1 of the third data, the first data may be CB2 and CB3 of the third data. Instead of using the pre-empted second resource to transmit the second data without transmitting the data that is initially scheduled to be transmitted on the second resource, in an implementation, the network device enables the joint coding of the second data for the second terminal device and the first data of the third data for the first terminal device. The first data is for the first terminal device and the second data is for the second terminal device, thus the joint coding between different terminal devices is enabled. In an implementation, the second data (e.g. URLLC data) may have a smaller payload size than the third data (e.g., eMBB data). In an example, the second data may also have a higher reliability requirement than the third data. In the following description, eMBB data will be taken as an example of the first data and the third data, and URLLC data will be taken as an example of the second data. The first terminal device may be called eMBB terminal device, and the second terminal device may be called URLLC terminal device.

The first data of the first terminal device and the second data of the second terminal device are jointly coded into the first codeword. The second data may be jointly coded with a part of the first data or jointly coded with the whole first data, to form the first codeword including the first data and the second data. As for which part of the first data is jointly coded with the second data, it may be configured (e.g., through an RRC signaling) or predefined, or may be indicated by the network device. The first codeword may include a plurality of encoded blocks generated by encoding the first data and the second data with an error correction code, and the plurality of encoded blocks may include a self-decodable encoded block corresponding to the second data. The self-decodable encoded block may be decodable independently of other encoded blocks of the plurality of encoded blocks of the first codeword, and the self-decodable encoded block may further be decodable jointly with one or more of the other encoded blocks of the plurality of encoded blocks of the first codeword. In other words, the second data (e.g., the URLLC data) may be self-decodable, and the second data may be jointly-decodable according to a self-decoding result of the second data.

In an implementation, Solution 1 or Solution 2 of the joint coding as described above may be applied for the joint coding here, in which the first data may be the eMBB data of Solution 1 and Solution 2 and the second data may be the URLLC data of Solution 1 and Solution 2. In a specific implementation, information bits of the first data and information bits of the second data may be multiplexed in a MAC layer and then encoded, which also enables joint coding. It should be noted that the solutions of the present disclosure can be applied to specific solutions where the first data (payload) and the second data (payload) are jointly coded, and can also be applied to specific solutions where a first MAC PDU (Protocol Data Unit) and a second MAC PDU are jointly coded. In the following, implementations for the specific solutions where the first data and the second data are jointly coded will be described as examples, and it should be noted that they could also be applied to the specific solutions where the first MAC PDU and the second MAC PDU are jointly coded.

For the implementation of the joint coding, there may be two manners as follows.

Manner 1: the first data and one CB of the second data may be jointly encoded into the first codeword (i.e., a joint codeword), where a corresponding CB index for the CB of the third data for forming the first codeword may be predefined or indicated (e.g., by DCI) or configured (e.g., through an RRC signaling). That is, which part of the third data is used as the first data for the joint coding and further which part of the first data is specifically jointly coded with the second data may be configured (e.g., through an RRC signaling) or predefined.

For example, one TB is scheduled for the third data, and the one TB may correspond to N+1 CBs, namely, CB0 to CBN (i.e., the n-th CB). The first part of the third data may be CB0 and CB1 of the third data, and the first data may be CB2 of the third data. The second data is jointly encoded with CB2 of the first data to form the first codeword. For another example, the first data may be CB2 and CB3 of the third data, and the second data is jointly encoded with CB2 of the first data to form the first codeword. It could be understood that in this case, the first codeword also includes information of CB3 which is a part of the first data but is not jointly coded with the second data. For still another example, the first data may be CB2 and CB3-CBN of the third data, and the second data is jointly encoded with CB2 of the first data to form the first codeword. It could be understood that in this case, the first codeword also includes information of CB3-CBN which are a part of the first data but are not jointly coded with the second data. For ease of description, the first codeword in this case will also be called jointly code data or joint codeword in the present disclosure.

In a specific implementation of Manner 1, a limitation of maximum encoded information length in channel coding is considered, and it is assumed that the maximum encoded information length is to be reached, e.g., with the total number of information bits being Nmax. When the second data and a CB of the third data are jointly encoded, the second data may occupy some of the information bits, resulting in the length of codable information of the CB being smaller than Nmax. Thus, in an example of the present disclosure, different CBs of the third data may have different payload sizes, for example, a payload size of CB2 may be smaller than payload sizes of CB3-CBN, and in this case, CB2 with the smaller payload size is jointly coded with the second data.

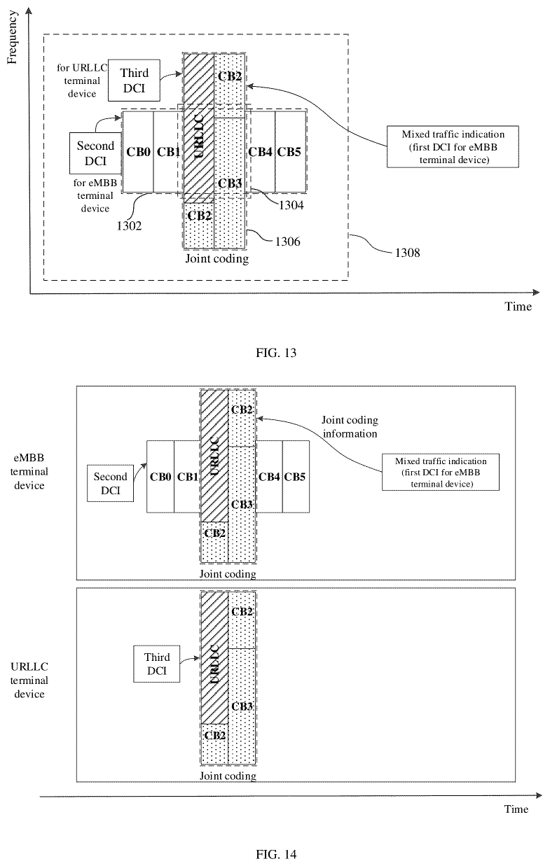

Manner 2: the first data and more than one CBs of the second data may be jointly encoded into the first codeword, where the number of CBs subject to the joint coding and corresponding CB indexes may be predefined or configured (e.g., through an RRC signaling). For example, the second data may be jointly encoded with two or more CBs of the third data to form the first codeword. Specifically, the second data and M CBs may be jointly encoded into M encoded blocks (where 1<M≤N), each encoded block including the second data. As shown in FIG. 13, which shows an example of joint coding between different terminal devices, the first part of the third data in this example is CB0 and CB1 of the third data, and the first data may be CB2 and CB3 of the third data. The second data is jointly encoded with CB2 and CB3 of the third data to form the first codeword. Specifically, the second data and 2 CBs (e.g., CB2 and CB3) may be jointly encoded into 2 encoded blocks, each encoded block including the second data. It can be understood that in other examples, the second data may be jointly encoded with the rest of the third data, e.g., CB2-CBN of the third data, which will not be elaborated. Specifically, the second data and N−1 CBs (e.g., CB2-CBN) may be jointly encoded into N−1 encoded blocks, each encoded block including the second data. Manner 2 can be beneficial for further improving reliability of the second data, e.g., the second data can be repeated and jointly encoded with multiple CBs.

In an implementation, the second data (URLLC data as shown in the shaded area of FIG. 13) in the first codeword (i.e., the joint codeword) is self-decodable. In addition, the second data and the CB2 and CB3 of the third data are jointly encoded into the first codeword, where the second data represents information of the second data, the CB2 and CB3 of the third data represents information of the first data, and after the joint coding, the first codeword contains information of the second data and the first data. It should be noted that the portion in the spotted area of FIG. 13 includes not only information of the CB2 and CB3 of the third data (e.g., corresponding to the larger code of FIG. 6a and FIG. 6b) but also information of some or all of bits of the second data embedded by joint coding. In this way, after a successful self-decoding of the second data in the shaded area, the second data can be used for enhancing the decoding of the CB2 and CB3 of the first data, since the correctly decoded second data provides prior information for the decoding of the portion in the spotted area which includes information of the CB2 and CB3 of the first data and some or all of bits of the second data that are already decoded correctly. Thus, augmented third data is achieved. However, for ease of description, the portion in the spotted area will be simply called CB2 and CB3 of the third data in the following description, and it should be understood that the portion in the spotted area also includes some or all bits of the second data embedded.

In the following description, Manner 2 will be taken as an example of the implementation of the joint coding. It should be understood that Manner 1 could also be applied.

The network device may schedule the first resource to be used for transmitting the first codeword. In an implementation, the first resource includes the second resource. That is, the second resource that is initially scheduled for the third data is now used for the first codeword. In other words, the second resource is an overlapped resource between the resource initially scheduled for the third data and the first resource.

The first terminal device may receive the first codeword from the network device. In an implementation, the first terminal device receives the first codeword from the network device on a PDSCH. A first RNTI is used for scrambling the PDSCH. In a specific implementation, since the joint coding is enabled for different terminal devices (i.e., the first terminal device and the second terminal device), the first RNTI (which may be called a joint RNTI or a mixed RNTI) may be different from a C-RNTI of the first terminal device and different from a C-RNTI of the second terminal device. That is, the first RNTI is used for joint coding between different terminal devices. Optionally, the first RNTI may be indicated in the first DCI or configured through an RRC signaling.

S1205, the network device sends first DCI to the first terminal device, where a first indication is carried in the first DCI and is indicative of joint coding on the first resource.

S1206, the first terminal device receives the first DCI from the network device.

The first indication in the first DCI may be indicative of the joint coding on the first resource. The first DCI may be indicative of resource information (e.g., time/frequency/spatial resources, RE portion, RE location, etc.) and decoding information (e.g., MCS, DMRS, etc.) of the first codeword including the first data and the second data. For example, the first DCI is indicative of at least one of: a coding rate of the first data, a coding rate of the second data, resource information of the second data, a code block index of the first data. Optionally, the first DCI may be further indicative of HARQ-related information (HARQ process ID, NDI, RV, feedback resource information, feedback timing information, etc.) and other information for the third data.

In an implementation, the network device may send the first DCI carrying the first indication to the first terminal device after transmitting the first codeword. In a further example, the network device may send the first DCI carrying the first indication to the first terminal device after transmitting the first codeword (including the first data and the second data) and the third data (except data initially scheduled on the pre-empted resource). For example, the first DCI may be sent in the next scheduling period or in the next PDCCH monitoring occasion of the first terminal device, such as in the next slot. It should be noted that timing of sending the first DCI is not limited to the above, as long as the first terminal device can obtain the above information related to the joint coding before decoding the received data.

In an implementation, for the first terminal device, there may be a reference resource region, which is predefined (e.g., agreed by both parties according to a protocol) or configured by the network device, e.g., through an RRC signaling. The first terminal device may buffer data received in the reference resource region. The first resource used for the first codeword and the resource initially scheduled for the third data are included in the reference resource region, so that the first terminal device not only can receive the third data based on the second DCI, but also can receive the first codeword on the first resource even if the first DCI for scheduling the first codeword has not been received, e.g., in some implementations where the first DCI is received in the next scheduling period or in the next PDCCH monitoring occasion. It should be noted that the reference resource region may be indicated to the first terminal device prior to the sending of the second DCI, the timing of such indication is not limited, as long as the receiving of normally scheduled data and possible jointly coded data for the first terminal device can be ensured.

In an implementation, there may be multiple manners for the first DCI to indicate the first resource in the reference resource region, including, for example, at least one of: an M-by-N time-frequency bitmap corresponding to the reference resource region, where M and N are integers greater than 0; an index in a resource allocation table corresponding to the reference resource region; a resource location of the first resource in the reference resource region.

S1207, the first terminal device performs decoding on received data according to the first DCI and the second DCI.

After receiving the first indication indicative of the joint coding on the first resource (e.g., in the next scheduling period or in the next PDCCH monitoring occasion, such as in the next slot), the first terminal device can determine that the second resource initially scheduled for the third data (for the first data thereof, exactly speaking) overlaps with at least part of the first resource. Then the first terminal device can determine that data initially scheduled on the second resource is not transmitted by the network device and that the first codeword including the first data and the second data is transmitted on the first resource including the second resource. At this time, the first terminal device can perform decoding on the received data to obtain the third data and the second data.

For the first codeword including the eMBB data (e.g., CB2 and CB3, corresponding to the larger code in FIG. 6a and FIG. 6b) and the URLLC data, in an implementation, the first terminal device may make multiple decoding attempts before requesting retransmission. In a first decoding attempt, the first terminal device performs self-decoding on the URLLC data according to the first DCI. Specifically, the self-decoding on the URLLC data may be performed after receiving a corresponding minimum of required code bits of the URLLC data. If the self-decoding of the URLLC data is successful, then the correctly decoded bits can be used to enhance decoding performance for the second data portion (e.g., the eMBB data), after a corresponding minimum of required code bits of the eMBB data are received. A second decoding attempt will be made especially if the self-decoding of the URLLC data fails. The first terminal device may proceed to attempt to jointly decode the URLLC data with the eMBB data (larger code). After the joint decoding, regardless of whether the eMBB data is decoded successfully or not, the joint decoding can increase a probability that the URLLC data will be successfully decoded. In this example, if the decoding of the eMBB data fails after the second (joint) decoding attempt, then the first terminal device may request a retransmission from the network device. With a retransmission, the first terminal device can make at least a third decoding attempt. It should be noted that with the retransmitted data, multiple decoding attempts may further be made, for example, to perform self-decoding from the retransmitted data, perform joint decoding from parts of the retransmitted data, and/or perform joint decoding using both the previously received first codeword and the retransmitted data. It should be noted that since only the eMBB data in the first codeword is for the first terminal device, the first terminal device may not perform the self-decoding for the URLLC data but only decoding the eMBB data.

In an implementation, the first terminal device may combine the first data obtained from the first codeword and data (e.g., CB0, CB1, CB4-CBN) received on the initially scheduled resource other than the second resource to obtain the combined third data. In this implementation, since the second data is for the second terminal device, the first terminal device can discard the second data.

After decoding the received data, the first terminal device performs feedback on the third data based on HARQ-related information, and the HARQ-related information includes feedback resource information and feedback timing information for the third data. In an implementation, the HARQ feedback may be based on the HARQ-related information included in the second DCI. In another implementation, the HARQ feedback may be based on the HARQ-related information included in the first DCI. If both of the first DCI and the second DCI include the HARQ-related information, whether to use the HARQ-related information from the first DCI or the second DCI may be predefined (for example, the first terminal device may simply ignore the HARQ-related information in the second DCI), or configured, e.g., through an RRC signaling.

Since the joint coding is enabled on the first resource, reliability of the data transmitted on the first resource can be improved. Further, since a resource initially scheduled for the first terminal device is used for the joint coding of the first data for the first terminal device and the second data for the second terminal device, not only can the latency and reliability requirements of the second data for the second terminal device be improved, but also the performance of the first terminal device can be ensured.

Now, more details and examples will be given for the joint coding between different terminal devices.

FIG. 13 shows an example of joint coding between different terminal devices according to one or more embodiments of the present disclosure.

In this example, when an eMBB terminal device (i.e., the first terminal device) is scheduled by second DCI to transmit DL eMBB data (i.e., the third data including, for example, one eMBB TB) on a resource 1302, DL URLLC data to a URLLC terminal device (i.e., the second terminal device) arrives during the transmission of the eMBB TB. The eMBB TB corresponds to five CBs, namely, CB0 to CB5. A network device re-allocates a resource scheduled for the eMBB terminal device to the URLLC terminal device. Re-allocating means that part of the resource is originally allocated to the eMBB terminal device and currently allocated to the URLLC terminal device. In this example, as shown in FIG. 14 which shows a schematic diagram of joint coding from perspectives of terminal devices, a resource (corresponding to a second resource 1304 of FIG. 13) initially scheduled by the second DCI for the CB2 and CB3 is re-allocated. Referring back to FIG. 13, the network device jointly encodes the URLLC data with partial eMBB data (e.g., CB2 and CB3) of the eMBB terminal device on the second resource 1304 to form the first codeword on a first resource 1306, and sends third DCI to the URLLC terminal device to indicate scheduling information to the URLLC terminal device. As for which part of the eMBB data is used for joint coding with the URLLC data, it may be indicated or configured by the network device or by a predefined rule. The predefined rule may be that the part of the eMBB data to be jointly coded is the CB(s) which is(are) scheduled to be transmitted on the overlapped resource between those indicated by the second DCI for the eMBB terminal device and those indicated by the third DCI for the URLLC terminal device, i.e., CB2 and CB3 (i.e., the first data as described above) in this example. It should be noted that if a part of CB2 is transmitted before the second data arrives, that is, the first terminal device receives only a part of the CB2, the whole CB2 may be used for joint coding. That is, the first codeword may include information of the whole CB2.

For specific implementations of the joint coding, the URLLC data can be joint encoded with one or multiple CBs of the eMBB data, which may be configured or pre-defined. In an example, the URLLC data is joint encoded with one CB of the eMBB data, which has the lowest CB index to be jointly encoded in the joint codeword (i.e., CB2). A benefit of this example is that fast URLLC decoding after receiving the joint codeword of the URLLC data and the one eMBB CB is realized. In another example, the URLLC data is joint encoded with multiple CBs. For instance, the URLLC data is joint encoded with all CBs to be jointly encoded in the joint codeword (CB2 and CB3 in FIG. 13 and FIG. 14). In this case, as described above, the portion in the spotted area of FIG. 13 and FIG. 14 includes not only the CB2 and CB3 of the eMBB data (e.g., corresponding to the larger code of FIG. 6a and FIG. 6b) but also some or all of bits of the URLLC data embedded by joint coding. A benefit of this example is that the URLLC reliability is further improved.

The URLLC terminal device decodes the URLLC data by joint decoding (the multiple decoding attempts as described above). For example, the URLLC terminal device self-decodes the URLLC data, and if failed, jointly decodes the URLLC data and the partial eMBB data (CB2 and CB3) in the joint codeword (i.e., the first codeword on the first resource 1306).

The network device sends a first indication (i.e., mixed traffic indication) in first DCI to the eMBB terminal device, e.g. in the next slot, to indicate the scheduling information for jointly coded data (i.e., the first codeword) in the previous slot. In this way, compared with the pre-emption solution in some embodiments where pre-empted information (CB2 and CB3) is not transmitted, the eMBB terminal device in FIG. 13 could obtain its whole coded information (e.g., by combining CB2 and CB3 from the first codeword with CB0, CB1, CB4, CB5 initially scheduled).

By utilizing the above mixed traffic cooperation, not only be the latency of the URLLC terminal device improved, but also the performance of the eMBB terminal device is ensured, since all eMBB data is transmitted.

In the following, more details will be given based on this example.

If the URLLC terminal device is configured with different types of joint coding, e.g., inter-UE joint coding and intra-UE joint coding, the third DCI indicates whether the joint coding is enabled, and whether the join coding is for the inter-UE joint coding or intra-UE joint coding. For example, there is an inter-UE mixed traffic indicator in the third DCI. The inter-UE mixed traffic indicator may be carried in a field of the third DCI which has 1 bit. The value of the field being ‘1’ may indicate that the inter-UE joint coding is enabled, and the value being ‘0’ may indicate that the inter-UE joint coding is disabled or indicate that the intra-UE joint coding is enabled. If the URLLC terminal device is configured with the inter-UE joint coding, the third DCI indicates whether the joint coding is enabled.

If the inter-UE joint coding is enabled, the third DCI indicates that the URLLC data is jointly encoded with some eMBB data, and indicates the time/frequency/spatial resources for the joint information. A PDSCH of the joint codeword is scrambled with a sequence, where the scrambling sequence generator shall be initialized with a mixed RNTI (corresponding to the first RNTI as described above) other than a C-RNTI, and the mixed RNTI is configured by the network device to the URLLC terminal device and the eMBB terminal device.

If the inter-UE joint coding is enabled in this transmission, the URLLC terminal device assumes that the mixed RNTI is used for PDSCH scrambling sequence generation; else if the inter-UE joint coding is disabled in this transmission, the URLLC terminal device assumes that the C-RNTI is used for PDSCH scrambling sequence generation.

The URLLC terminal device decodes the URLLC data by self-decoding, and joint-decoding with the eMBB data, i.e. two attempts for decoding as described above. The URLLC terminal device discards the received eMBB data.

For the eMBB terminal device, there is a reference DL resource region (corresponding to the reference resource region as described above) configured by the network device or pre-defined, as shown by the dashed box 1308 in FIG. 13. Further, FIG. 15 shows a schematic diagram of an example of a reference resource region for the eMBB terminal device. The eMBB terminal device needs to buffer the received data in the reference DL resource of the reference DL resource region 1502.

For the eMBB terminal device, generally, slot-based scheduling is configured by the network device, and DCI monitor periodicity is a slot. When the second DCI indicates the resource for the DL eMBB TB in the PDSCH, the eMBB terminal device does not know partial of its scheduled resource is re-allocated to another URLLC terminal device. In the next slot, the first indication in the first DCI indicates that part of the resource is re-allocated to the URLLC terminal device and indicates that the joint coding occurs in the previous slot.

So the first DCI carrying the first indication is special DCI (called mixed traffic indication DCI), which is an indication of time and/or frequency region of an impacted eMBB resource to respective eMBB terminal device(s). The “impacted” resource means a resource for the jointly coded codeword of the partial eMBB data and another URLLC data. By checking the overlapped region of the “impacted” resource(s) and the scheduled resource(s) by the second DCI, the eMBB terminal device knows which part of the scheduled resource has been used by another downlink transmission.

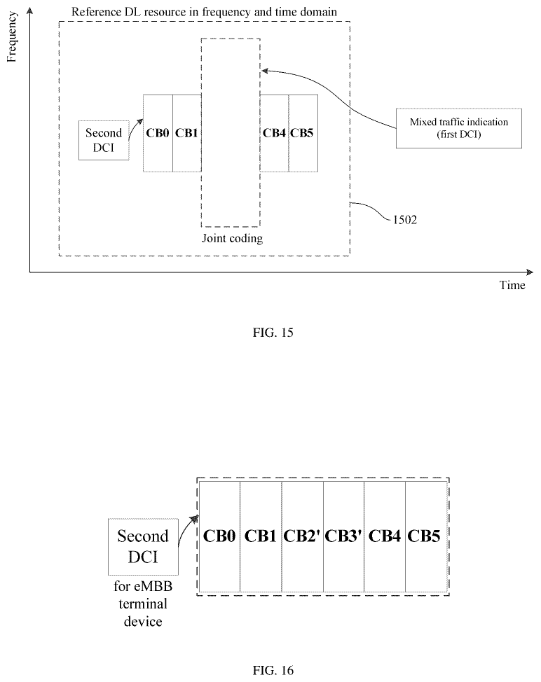

For the buffer management of the eMBB terminal device, according to the second DCI for eMBB scheduling, the eMBB terminal device puts the received data in the scheduled time and frequency resources to the soft buffer. As shown in FIG. 16, which shows a schematic diagram of an example of buffer management, the eMBB terminal device puts CB0, CB1, CB2′, CB3′, CB4 and CB5 in the scheduled time and frequency resources to the soft buffer. The CB2′ and CB3′ here are actually data on the pre-empted resource, which is not CB2 and CB3 any more since the pre-empted resource is re-allocated for another transmission. After receiving the mixed traffic indication, the eMBB terminal device knows which part of the scheduled resource (i.e., the second resource 1304 in FIG. 13) has been used by another downlink transmission, and knows the first resource (i.e., the first resource 1306 in FIG. 13) for the jointly coded codeword (first codeword) of the partial eMBB data and another URLLC data. So the eMBB terminal device uses the received data (i.e., CB2 and CB3) in the first resource 1306 to replace the received data (i.e., CB2′ and CB3′) in the second resource 1304 to the soft buffer.

As for how to indicate the time and/or frequency region of the impacted eMBB resources to respective eMBB terminal device(s), multiple alternatives are provided. In a first alternative, an M-by-N time-frequency bitmap indicates resources within the reference DL resource, where the value of M and/or N is configured or predefined. In a second alternative, an index in a time-frequency allocation table is used, where the time-frequency allocation table is predefined or configured, a row in the table indicating a time and frequency resource. In a third alternative, an index in a time allocation table, and RBs or RBGs in the reference DL resource are used, where the time allocation table is predefined or configured. A row in the table indicates a time-domain resource, and the network device also indicates the frequency location for the resource, e.g., indicates the RBs or RBGs locations.

The first DCI also indicates the scheduling information in the previous resource for the joint codeword. The scheduling information includes, but is not limited to, at least one of the following: the mixed RNTI value for determining the PDSCH scrambling sequence; MCS of URLLC and/or eMBB in the joint coded data; REs used by URLLC (e.g. the RE portion in the indicated resource); eMBB CB index(es) in the joint decoded data. Alternatively, eMBB CB index(es) in the jointly coded data may be determined by a predefined rule: CBs which are not transmitted and/or CBs which are partially transmitted in the non-overlapped resource before the URLLC data arrives are determined to be put into the jointly coded data.

After receiving the scheduling information in the mixed traffic indication, the eMBB terminal device could decode its partial data in the joint codeword in the indicated resource (i.e., the first resource) for the joint coding. By HARQ combing the two partial data (one part is scheduled by the second DCI, another part is jointly encoded with another URLLC data), the eMBB terminal device could decode the data.

It should be noted that in some embodiments, S1201 and S1202 may not be necessary. For example, due to scheduling requirements of both URLLC data for the second terminal device and eMBB data for the first terminal device, the network device may directly schedule jointly coded data of the URLLC data and at least part of the eMBB data without scheduling the eMBB data first. The parts of these embodiments that are same as the above embodiments will not be repeated here.

In the present disclosure, PDSCH processing delay is further considered for the joint coding. In the related art, if a first uplink symbol of the PUCCH which carries the HARQ-ACK information, as defined by the assigned HARQ-ACK timing K₁ and K_{offset}, if configured, and the PUCCH resource to be used and including the effect of the timing advance, starts no earlier than at symbol L₁, where L₁ is defined as the next uplink symbol with its CP starting after

$$\text{?}$$

$$\text{?} \text{indicates text missing or illegible when filed}$$

after the end of the last symbol of the PDSCH carrying the TB being acknowledged, then a terminal device shall provide a valid HARQ ACK/NACK message. The reference time for the start of PDSCH processing is: the end of the last symbol of the PDSCH carrying the TB being acknowledged. (Reference can be made to 3GPP NR specification TS 38.214 V17.2.0 for definitions of related parameters.)

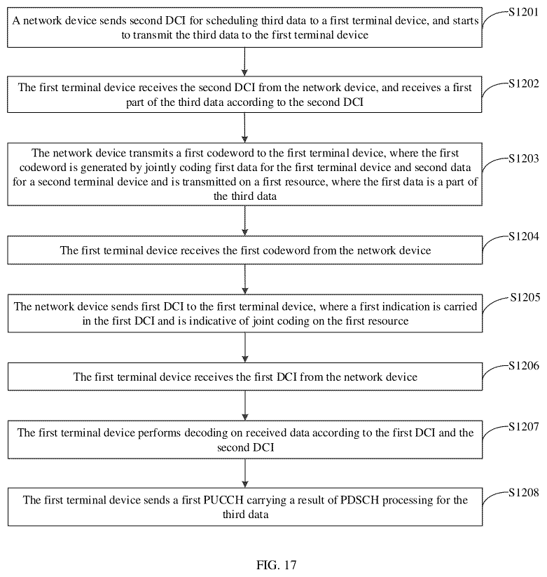

FIG. 17 is a schematic flowchart of yet another wireless communication method according to one or more embodiments of the present disclosure, where PDSCH processing delay is considered. Based on the embodiments of FIG. 12, the method may further include:
S1208, the first terminal device sends a first PUCCH carrying a result of PDSCH processing for the third data.

The first PUCCH may carry HARQ ACK/NACK information for the third data (e.g., the eMBB data). For the joint coding between different terminal devices, the first terminal device (the eMBB terminal device) may need to perform two decoding, one is decoding partial data in a first transmission (i.e., the initially scheduled transmission), another is decoding remaining partial data in a second transmission (i.e., a transmission of the joint codeword for the second data and the first data). In addition, the first terminal device knows there is the second transmission after the PDSCH transmission, e.g., in the next slot by the first indication in the first DCI. So the PDSCH processing delay in this case may be different from regular NR PDSCH processing delay.

In an implementation, the sending of the first PUCCH may start not earlier than first processing time after an end of a time unit of a PDCCH carrying the first DCI, or, not earlier than second processing time after the end of the time unit of the PDCCH carrying the first DCI. The second processing time may equal to the first processing time plus a time offset, where the time offset may be predefined or configured through an RRC signaling. That is, the first processing time may correspond to Tproc for eMBB. Further, in an example, the end of the time unit of the PDCCH carrying the first DCI may correspond to reference time for start of PDSCH processing for eMBB. In another example, the end of the time unit of the PDCCH carrying the first DCI plus the time offset may correspond to reference time for start of PDSCH processing for eMBB, so that the sending of the first PUCCH starts not earlier than the second processing time after the end of the time unit of the PDCCH carrying the first DCI. The time unit may also be a symbol, for example. Then, the sending of the first PUCCH starts not earlier than at symbol L₁ (as in TS 38.214 V17.2.0 except that joint coding is considered). After the end of the time unit of the PDCCH carrying the first DCI, decoding for the third data could be performed. The first processing time may correspond to a first processing capability of the first terminal device for processing the third data. The first processing time (or the first processing capability) may be reported by the first terminal device to the network device or may be predefined. Since the time for processing the third data is considered, the first terminal device can provide valid HARQ ACK/NACK information in the first PUCCH.

In another implementation, the sending of the first PUCCH may start not earlier than third processing time after an end of a time unit of a PDSCH scheduled by the second DCI. In an example of this implementation, the end of the time unit of the PDSCH scheduled by the second DCI plus a time offset may correspond to reference time for start of PDSCH processing for eMBB. Different time offsets may be provided for different situations. For example, time offset 1 may be used for a situation of regular joint coding, time offset 2 may be used for a situation of intra-UE joint coding, and time offset 3 may be used for a situation of inter-UE joint coding. In the situation of inter-UE joint coding, the end of the time unit of the PDSCH scheduled by the second DCI plus the time offset 3 may correspond to the reference time for start of PDSCH processing for eMBB, so that the sending of the first PUCCH starts not earlier than the third processing time after the end of the time unit of the PDSCH scheduled by the second DCI. The time unit may also be a symbol, for example. Then, the sending of the first PUCCH starts not earlier than at symbol L₁ (as in TS 38.214 V17.2.0 except that joint coding is considered). After the end of the time unit of the PDSCH scheduled by the second DCI, decoding for the third data could be performed, on the condition that the joint coding between different terminal devices is considered. The third processing time here may correspond to a third processing capability of the first terminal device for processing the third data in the situation of joint coding between different terminal devices. The third processing time (or the third processing capability) may be reported by the first terminal device to the network device or may be predefined. Since the time for processing the third data is considered, the first terminal device can provide valid HARQ ACK/NACK information in the first PUCCH.

In a further implementation, depending on the coding scheme, there may be multiple types of processing time including, for example, processing time (Tproc-0) for non-joint coding, processing time (Tproc-1) for joint coding in a terminal device, processing time (Tproc-2) for joint coding between different terminal devices, etc.

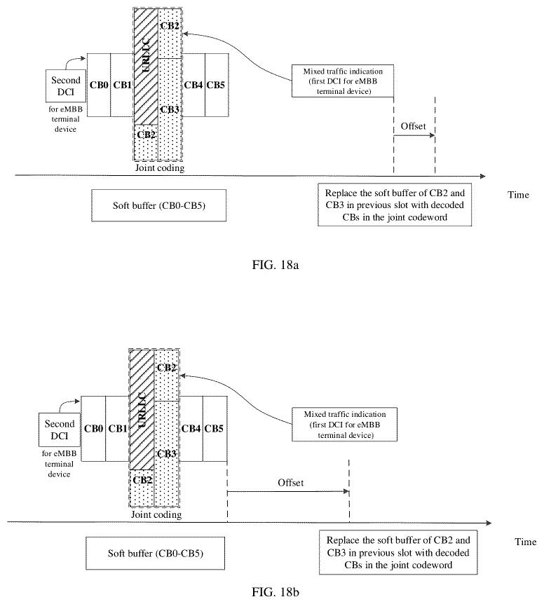

FIG. 18a and FIG. 18b show schematic diagram of examples of PDSCH processing for joint coding of FIG. 13. In these examples, PDSCH processing for the eMBB terminal device is considered for the inter-UE joint coding.

In an implementation, as shown in FIG. 18a, the reference time for the start of PDSCH processing is the end of the mixed traffic indication (the first DCI), or the end of the mixed traffic indication (the first DCI) plus an offset, the offset being predefined or configured. The first DCI indicates that inter-UE joint coding occurs in the previous time slot(s). If the first uplink symbol of the PUCCH which carries the HARQ-ACK information, and the PUCCH resource to be used and including the effect of the timing advance, starts no earlier than at symbol L₁ where L₁ is defined as the next uplink symbol with its CP starting after Tproc (e.g., the first processing time) after the reference time, then the UE shall provide a valid HARQ-ACK message. Tproc is PDSCH processing time.

In another implementation, as shown in FIG. 18b, the reference time for the start of PDSCH processing is the end of the symbol of the PDSCH carrying the eMBB TB being acknowledged plus an offset, the offset being predefined or configured by the network device. There are multiple offsets for the joint coding. For example, Offset 1 (the above time offset 1) is for a case that the URLLC data and the whole eMBB data are jointly encoded (i.e., the regular joint coding). Offset 2 (the above time offset 2) is for the intra-UE joint coding. In an implementation of the intra-UE joint coding, partial eMBB data is transmitted and original eMBB transmission is stopped, and a subsequent joint codeword of URLLC data and partial eMBB data (which is not transmitted in the original transmission) is transmitted, thus the first terminal device needs to combine the two transmissions to decode the eMBB data. Offset 3 (the above time offset 3) is for the inter-UE mixed traffic cooperation, where occurrence of inter-UE joint coding is indicated after eMBB PDSCH transmission, e.g., by the first DCI in the next slot. If the first uplink symbol of the PUCCH which carries the HARQ-ACK information, and the PUCCH resource to be used and including the effect of the timing advance, starts no earlier than at symbol L₁ where L₁ is defined as the next uplink symbol with its CP starting after Tproc after the reference time, then the UE shall provide a valid HARQ-ACK message. Tproc is PDSCH processing time. Optionally, there are multiple types of processing time, depending on the coding scheme. For example, Tproc-0 is for non-joint coding; Tproc-1 is for the intra-UE joint coding; and Tproc-2 is for inter-UE joint coding.

By taking joint coding types and joint decoding complexity into account to define the reference time for PDSCH processing for the data, accuracy and reliability of the HARQ ACK/NACK feedback can be ensured.

With the wireless communication method provided by the present disclosure, firstly, since the joint coding is enabled on the first resource, reliability of data transmitted on the first resource can be improved. Further, the first data for the first terminal device and the second data for the second terminal device can be jointly coded on the first resource. After receiving the first indication, the first terminal device can determine that a resource initially scheduled for the first terminal device is used for the joint coding of the first data for the first terminal device and the second data for the second terminal device. In this way, not only can the latency and reliability requirements of the second data for the second terminal device be improved, but also the performance of the first terminal device can be ensured.

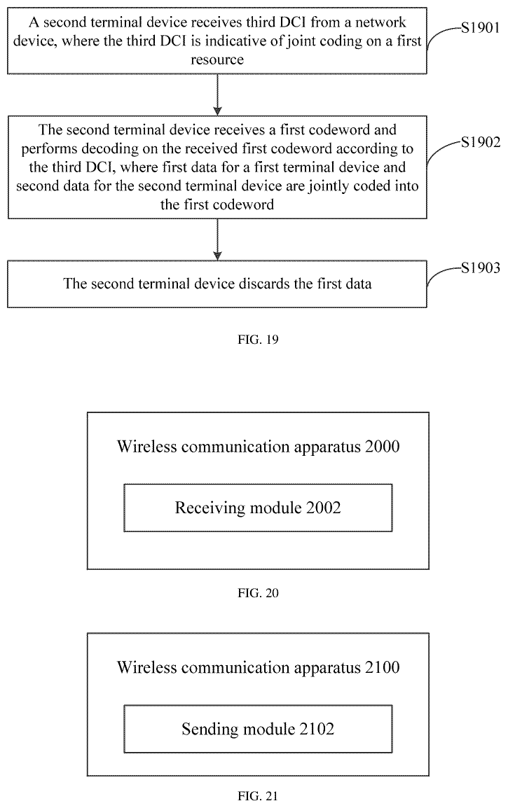

Next, a wireless communication method of the present disclosure will be described from the perspective of a second terminal device (e.g., a URLLC terminal device) in combination with FIG. 19. FIG. 19 shows a schematic flowchart of again another wireless communication method according to one or more embodiments of the present disclosure. The method can be implemented by a second terminal device. As shown in FIG. 19, the method can include the following steps.

S1901, a second terminal device receives third DCI from a network device, where the third DCI is indicative of joint coding on a first resource.

S1902, the second terminal device receives a first codeword and performs decoding on the received first codeword according to the third DCI, where first data for a first terminal device and second data for the second terminal device are jointly coded into the first codeword.

S1903, the second terminal device discards the first data.

For S1901 to S1903, reference may be made to the description in the above method embodiments. Technical principles and technical effects thereof are similar and will not be repeated here. It could be understood that the scheduling manner of the third DCI for the first codeword may be the same as that of the first DCI for the first codeword as described above, e.g., in terms of indication of resource information, decoding information, feedback manner, feedback timing information and resource information, etc.

Next, embodiments of products related to the wireless communication methods will be described.

FIG. 20 shows a schematic structural diagram of a wireless communication apparatus according to one or more embodiments of the present disclosure. As shown in FIG. 20, the wireless communication apparatus 2000 may include:
a receiving module 2002, configured to: receive a first indication from a network device, where the first indication is indicative of joint coding on a first resource.

In a possible implementation, the joint coding on the first resource is joint coding for first data for a first terminal device including the apparatus and second data for a second terminal device.

In a possible implementation, the first data of the first terminal device and the second data of the second terminal device are jointly coded into a first codeword; where the first codeword includes a plurality of encoded blocks generated by encoding the first data and the second data with an error correction code, and the plurality of encoded blocks include a self-decodable encoded block corresponding to the second data, where the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

In a possible implementation, the first indication is carried in first downlink control information (DCI); where the first DCI is indicative of at least one of: a coding rate of the first data, a coding rate of the second data, resource information of the second data, a code block index of the first data.

In a possible implementation, the first DCI is indicative of the first resource in a reference resource region by at least one of: an M-by-N time-frequency bitmap corresponding to the reference resource region, where M and N are integers greater than 0; an index in a resource allocation table corresponding to the reference resource region; a resource location of the first resource in the reference resource region; where the reference resource region is configured through a radio resource control (RRC) signaling or predefined.

In a possible implementation, the apparatus 2000 further includes a processing module, configured to buffer data received in the reference resource region.

In a possible implementation, a first radio network temporary identifier (RNTI) is used for scrambling a physical downlink shared channel (PDSCH) for the first data and the second data.

In a possible implementation, the first RNTI is different from a cell-radio network temporary identifier (C-RNTI) of the first terminal device, and the first RNTI is different from a C-RNTI of the second terminal device.

In a possible implementation, the first RNTI is indicated in the first DCI or configured through an RRC signaling.

In a possible implementation, the receiving module 2002 is further configured to receive second DCI from the network device, where the second DCI is used for scheduling third data, and the third data includes the first data.

In a possible implementation, feedback on the third data is performed by the first terminal device based on HARQ-related information included in the second DCI, and the HARQ-related information includes feedback resource information and feedback timing information for the third data.

In a possible implementation, the apparatus 2000 further includes a processing module, configured to: determine that a second resource scheduled by the second DCI for the third data overlaps with at least part of the first resource; determine that data scheduled by the second DCI on the second resource is not transmitted by the network device.

In a possible implementation, the apparatus 2000 further includes a sending module, configured to send a first physical uplink control channel (PUCCH) carrying a result of PDSCH processing for the third data to the network device.

In a possible implementation, the sending of the first PUCCH starts not earlier than first processing time after an end of a time unit of a physical downlink control channel (PDCCH) carrying the first DCI, or, not earlier than second processing time after the end of the time unit of the PDCCH carrying the first DCI, where the second processing time equals to the first processing time plus a time offset.

In a possible implementation, the sending of the first PUCCH starts not earlier than third processing time after an end of a time unit of a PDSCH scheduled by the second DCI.

In a possible implementation, the first processing time and/or the third processing time is predefined, or is reported by the first terminal device to the network device.

In a possible implementation, the second data has a smaller payload size than the third data.

The wireless communication apparatus may be applied to the first terminal device as described in the above method embodiments or may be the first terminal device as described in the above method embodiments. It should be understood by a person skilled in the art that, the relevant description of the above modules in the embodiments of the present disclosure may be understood with reference to the relevant description of the wireless communication method in the embodiments of the present disclosure.

FIG. 21 shows a schematic structural diagram of another wireless communication apparatus according to one or more embodiments of the present disclosure. As shown in FIG. 21, the wireless communication apparatus 2100 may include:
a sending module 2102, configured to send a first indication to a first terminal device, where the first indication is indicative of joint coding on a first resource.

In a possible implementation, the joint coding on the first resource is joint coding for first data for the first terminal device and second data for a second terminal device.

In a possible implementation, the first data of the first terminal device and the second data of the second terminal device are jointly coded into a first codeword; where the first codeword includes a plurality of encoded blocks generated by encoding the first data and the second data with an error correction code, and the plurality of encoded blocks include a self-decodable encoded block corresponding to the second data, where the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

In a possible implementation, the first indication is carried in first downlink control information (DCI); where the first DCI is indicative of at least one of: a coding rate of the first data, a coding rate of the second data, resource information of the second data, a code block index of the first data.

In a possible implementation, the first DCI is indicative of the first resource in a reference resource region by at least one of: an M-by-N time-frequency bitmap corresponding to the reference resource region, where M and N are integers greater than 0; an index in a resource allocation table corresponding to the reference resource region; a resource location of the first resource in the reference resource region; where the reference resource region is configured through a radio resource control (RRC) signaling or predefined.

In a possible implementation, a first radio network temporary identifier (RNTI) is used for scrambling a physical downlink shared channel (PDSCH) for the first data and the second data.

In a possible implementation, the first RNTI is different from a cell-radio network temporary identifier (C-RNTI) of the first terminal device, and the first RNTI is different from a C-RNTI of the second terminal device.

In a possible implementation, the first RNTI is indicated in the first DCI or configured through an RRC signaling.

In a possible implementation, the sending module 2102 is further configured to send second DCI to the first terminal device, where the second DCI is used for scheduling third data, and the third data includes the first data.

In a possible implementation, the apparatus 2100 further includes: a receiving module, configured to receive feedback on the third data performed by the first terminal device based on HARQ-related information included in the second DCI, where the HARQ-related information includes feedback resource information and feedback timing information for the third data.

In a possible implementation, the apparatus 2100 further includes: a receiving module, configured to receive a first physical uplink control channel (PUCCH) carrying a result of PDSCH processing for the third data.

In a possible implementation, sending of the first PUCCH by the first terminal device starts not earlier than first processing time after an end of a time unit of a physical downlink control channel (PDCCH) carrying the first DCI, or, not earlier than second processing time after the end of the time unit of the PDCCH carrying the first DCI, where the second processing time equals to the first processing time plus a time offset.

In a possible implementation, sending of the first PUCCH by the first terminal device starts not earlier than third processing time after an end of a time unit of a PDSCH scheduled by the first DCI.

In a possible implementation, the first processing time and/or the third processing time is predefined, or is reported by the first terminal device to the network device.

In a possible implementation, the second data has a smaller payload size than the third data.

The wireless communication apparatus may be applied to the network device as described in the above method embodiments or may be the network device as described in the above method embodiments. It should be understood by a person skilled in the art that, the relevant description of the above modules in the embodiments of the present disclosure may be understood with reference to the relevant description of the wireless communication method in the embodiments of the present disclosure.

An embodiment of the present disclosure provides a terminal device including processing circuitry for executing any of the above wireless communication methods. It should be understood that the terminal device can execute the steps performed by the first or second terminal device in the above method embodiments, which will not be repeated here.

An embodiment of the present disclosure provides a network device including processing circuitry for executing any of the above wireless communication methods. It should be understood that the network device can execute the steps performed by the network device in the above method embodiments, which will not be repeated here.

An embodiment of the present disclosure provides a wireless communication apparatus which includes a processor and a memory. The memory is storing instructions that cause the processor to perform any of the above wireless communication methods.

An embodiment of the present disclosure provides a wireless communication system, including a network device, a first terminal device and a second terminal device. The first terminal device is configured to execute the steps executed by the first terminal device in any of the above wireless communication methods, the second terminal device is configured to execute the steps executed by the second terminal device in any of the above wireless communication method, and the network device is configured to execute the steps executed by the network device in any of the above wireless communication methods.

An embodiment of the present disclosure provides a computer-readable medium storing computer execution instructions which, when executed by a processor, causes the processor to execute any of the above wireless communication methods.

An embodiment of the present disclosure provides a computer program product including computer execution instructions which, when executed by a processor, causes the processor to execute any of the above wireless communication methods.

Although the present disclosure describes methods and processes with steps in a certain order, one or more steps of the methods and processes may be omitted or altered as appropriate. One or more steps may take place in an order other than that in which they are described, as appropriate.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration information, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may include a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

Although embodiments have been described above with reference to the accompanying drawings, those of skill in the art will appreciate that variations and modifications may be made without departing from the scope thereof as defined by the appended claims.

What is claimed is:

1. A method, comprising:
receiving a first indication from a network device, wherein the first indication is indicative of joint coding on a first resource.

2. The method according to claim 1, wherein the joint coding on the first resource is joint coding for first data for a first terminal device and second data for a second terminal device.

3. The method according to claim 2, wherein the first data and the second data are jointly coded into a first codeword; and
wherein the first codeword comprises a plurality of encoded blocks generated by encoding the first data and the second data with an error correction code, and the plurality of encoded blocks comprise a self-decodable encoded block corresponding to the second data, wherein the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

4. The method according to claim 2, wherein the first indication is carried in first downlink control information (DCI); and
wherein the first DCI is indicative of at least one of: a coding rate of the first data, a coding rate of the second data, resource information of the second data, or a code block index of the first data.

5. The method according to claim 4, wherein the first DCI is indicative of the first resource in a reference resource region by at least one of:
an M-by-N time-frequency bitmap corresponding to the reference resource region, wherein M and N are integers greater than 0;
an index in a resource allocation table corresponding to the reference resource region; or
a resource location of the first resource in the reference resource region;
wherein the reference resource region is configured through a radio resource control (RRC) signaling or predefined.

6. A method, comprising:
sending a first indication to a first terminal device, wherein the first indication is indicative of joint coding on a first resource.

7. The method according to claim 6, wherein the joint coding on the first resource is joint coding for first data for the first terminal device and second data for a second terminal device.

8. The method according to claim 7, wherein the first data and the second data are jointly coded into a first codeword; and
wherein the first codeword comprises a plurality of encoded blocks generated by encoding the first data and the second data with an error correction code, and the plurality of encoded blocks comprise a self-decodable encoded block corresponding to the second data, wherein the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

9. The method according to claim 7, wherein the first indication is carried in first downlink control information (DCI); and
wherein the first DCI is indicative of at least one of: a coding rate of the first data, a coding rate of the second data, resource information of the second data, or a code block index of the first data.

10. The method according to claim 9, wherein the first DCI is indicative of the first resource in a reference resource region by at least one of:
an M-by-N time-frequency bitmap corresponding to the reference resource region, wherein M and N are integers greater than 0;
an index in a resource allocation table corresponding to the reference resource region; or
a resource location of the first resource in the reference resource region;
wherein the reference resource region is configured through a radio resource control (RRC) signaling or predefined.

11. An apparatus, comprising:
at least one processor coupled with memory storing instructions, wherein when the at least one processor executes the instructions, the apparatus is caused to:
receive a first indication from a network device, wherein the first indication is indicative of joint coding on a first resource.

12. The apparatus according to claim 11, wherein the joint coding on the first resource is joint coding for first data for a first terminal device comprising the apparatus and second data for a second terminal device.

13. The apparatus according to claim 12, wherein the first data and the second data are jointly coded into a first codeword; and
wherein the first codeword comprises a plurality of encoded blocks generated by encoding the first data and the second data with an error correction code, and the plurality of encoded blocks comprise a self-decodable encoded block corresponding to the second data, wherein the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

14. The apparatus according to claim 12, wherein the first indication is carried in first downlink control information (DCI); and
wherein the first DCI is indicative of at least one of: a coding rate of the first data, a coding rate of the second data, resource information of the second data, or a code block index of the first data.

15. The apparatus according to claim 14, wherein the first DCI is indicative of the first resource in a reference resource region by at least one of:
an M-by-N time-frequency bitmap corresponding to the reference resource region, wherein M and N are integers greater than 0;
an index in a resource allocation table corresponding to the reference resource region; or
a resource location of the first resource in the reference resource region;
wherein the reference resource region is configured through a radio resource control (RRC) signaling or predefined.

16. An apparatus, comprising:
at least one processor coupled with memory storing instructions, wherein when the at least one processor executes the instructions, the communication apparatus is caused to:
send a first indication to a first terminal device, wherein the first indication is indicative of joint coding on a first resource.

17. The apparatus according to claim 16, wherein the joint coding on the first resource is joint coding for first data for the first terminal device and second data for a second terminal device.

18. The apparatus according to claim 17, wherein the first data and the second data are jointly coded into a first codeword; and
wherein the first codeword comprises a plurality of encoded blocks generated by encoding the first data and the second data with an error correction code, and the plurality of encoded blocks comprise a self-decodable encoded block corresponding to the second data, wherein the self-decodable encoded block is decodable independently of other encoded blocks of the plurality of encoded blocks of the first codeword, and the self-decodable encoded block is further decodable jointly with one or more of the other encoded blocks of the plurality of encoded blocks of the first codeword.

19. The apparatus according to claim 17, wherein the first indication is carried in first downlink control information (DCI); and
wherein the first DCI is indicative of at least one of: a coding rate of the first data, a coding rate of the second data, resource information of the second data, or a code block index of the first data.

20. The apparatus according to claim 19, wherein the first DCI is indicative of the first resource in a reference resource region by at least one of:
an M-by-N time-frequency bitmap corresponding to the reference resource region, wherein M and N are integers greater than 0;
an index in a resource allocation table corresponding to the reference resource region; or
a resource location of the first resource in the reference resource region;
wherein the reference resource region is configured through a radio resource control (RRC) signaling or predefined.
